(19) United States
(12) Patent Application Publication
(10) Pub. No.: US 2024/0005315 A1
(43) Pub. Date: Jan. 4, 2024

(54) COMPUTATIONALLY VERIFIABLE SMART CONTRACT-TYPE INFRASTRUCTURE FOR DISTRIBUTED COMPUTING AND/OR COMMUNICATIONS NETWORKS

(71) Applicant: Oluwamide Michael Agunloye, Winnetka, CA (US)

(72) Inventor: Oluwamide Michael Agunloye, Winnetka, CA (US)

(21) Appl. No.: 18/344,686

(22) Filed: Jun. 29, 2023

Related U.S. Application Data
(60) Provisional application No. 63/357,533, filed on Jun. 30, 2022.

(51) Int. Cl. G06Q 20/38; G06Q 30/0234

(52) U.S. Cl. CPC G06Q 20/389; G06Q 20/381; G06Q 30/0234

(57) ABSTRACT

The present disclosure relates generally to infrastructure for distributed computing and/or communications networks and, more particularly, to computationally verifiable smart-contract-type infrastructure for distributed computing and/or communications networks.

This application claims priority from U.S. Provisional Patent Application Ser. No. 63/357,533, filed Jun. 30, 2022, entitled “Computationally Verifiable Smart Contract-Type Infrastructure for Distributed Computing and/or Communications Networks,” incorporated herein by reference in its entirety.

### BACKGROUND

### Field

The present disclosure relates generally to infrastructure for distributed computing and/or communications networks and, more particularly, to computationally verifiable smart-contract-type infrastructure for distributed computing and/or communications networks.

### Information

Distributed computing and/or communications networks and/or associated technologies, which may include, for example, distributed ledger technologies (DLT) or the like, are becoming more and more prominent and may play an important role in the future of computing or like technology. These or like technologies may form, in whole or in part, one or more on-line community-driven platforms and/or systems, such as a foundation for digital or cryptocurrencies and/or various forms of cybersecurity technologies, for example. However, these or like technologies, including cryptocurrency or like technologies, for example, may pose significant challenges in promoting widespread adoption and/or implementation thereof, which may include, for example, relatively large utilization fees borne by end users and/or due, at least in part, to technological hurdles faced by users trying to engage with and/or utilize such technologies.

### SUMMARY

Embodiments may include an example process, comprising electronically generating one or more computationally verifiable smart contract templates substantially in accordance with at least layer 0 and/or layer 1 of one or more distributed network technologies. In implementations, the one or more computationally verifiable smart contract templates may comprise one or more maker and/or taker templates. Also, in implementations, the one or more distributed network technologies may comprise one or more blockchain-type technologies. In implementations, the maker and/or taker templates may comprise self-validating characteristics. Further, in implementations, the example process may include obtaining an input from a maker, wherein the input obtained from the maker to indicate initiation of a claim via an exchange contract to offer to obtain a particular amount of a first cryptographic asset in exchange for a particular amount of a second cryptographic asset. In implementations, the exchange contract may comprise a cryptographic protocol to manage an exchange of cryptographic assets between at least the maker and the taker.

Additionally, implementations of the example process may include obtaining an input from a taker, wherein the input obtained from the taker may indicate an intent to perform a swap of the particular amount of the first cryptographic asset for the particular amount of the second cryptographic asset. The example process may further include the taker user appending a claim to the existing claim via the exchange contract to indicate the taker's intent to perform the swap of cryptographic assets. In implementations, the exchange contract may recruit a validator. Also, in implementations, the example process may include the exchange contract communicating with a calculation contract to determine compensation for the maker to receive as a rebate. In implementations, the exchange contract may instruct a treasury contract to prepare to pay the rebate to the maker following the exchange of cryptographic assets. In implementations, the exchange contract may instruct the maker, taker and validator to register threshold keys and to trade IDs. Additionally, the example process may include, as part of a process to exchange the cryptographic assets between the maker and the taker, generating two messages per maker, taker and validator parties.

In implementations, the example process may include the maker and taker parties individually communicating respective messages, wherein the messages may respectively comprise digital asset threshold key shares. In implementations, the maker and taker parties may individually communicate the respective messages to at least one of the following: a server; a decentralized network; or any combination thereof. Further, the maker message may include threshold shares for the maker's cryptographic asset, wherein the maker's asset may comprise an Ethereum asset. Also, in implementations, the taker message may include threshold shares for the taker's cryptographic asset. In implementations, the messages may include a plurality of parameters, including asset address/fingerprint, signature scheme, curve name, publicRvalue, curvexy, hash name or curvegenerator, or any combination thereof. Also, in implementations, the messages may further include metadata comprising one or more private keys and one or more secret numbers.

Further, in implementations, the private keys may be homomorphically encrypted and/or the secret numbers may be homomorphically encrypted. In implementations, the example process may include generation of initial threshold homomorphic keypairs to be utilized in communicating a first message from the maker to the taker. The example process may further include generation of a prime variant of the initial threshold homomorphic keypairs to be utilized in communicating a second message from the taker to the maker.

In implementations, communicating the first message from the maker to the taker and the communicating the second message from the taker to the maker may be performed substantially concurrently. Also, in implementations, the concurrent communication of messages may be performed via first and second instances of a particular protocol, wherein the particular protocol may include a re-encryption key validation process and/or a message validation and delivery process. In implementations, the first and second instances of the particular protocol, including the re-encryption key validation process and the message validation and delivery process, may be performed in a substantially interleaved fashion. The re-encryption key validation process may include a process to re-encrypt previously encrypted content with a new desired key without revealing the key, for example.

Also, in implementations, the process to re-encrypt the previously encrypted content may comprise homomorphic encryption of the previously encrypted content. In implementations, the message validation and delivery process may include performing an algorithm (e.g., Southern Algorithm) to match a private component of a message to a public identifier for the message in cleartext. The private component of the message may comprise a private key and/or the public identifier for the message may comprise a public key, for example. In implementations, the message validation and delivery process may further include performing a homomorphic variant and/or equivalent (e.g., Northern Algorithm) of the Southern Algorithm, for example. In implementations, the Southern Algorithm may include generating digital asset addresses, public keys, signatures, fingerprints or pre-image hashes, or any combination thereof, and/or performing verification processes on the generated digital asset addresses, public keys, signatures, fingerprints and/or pre-image hashes. In implementations, the Northern Algorithm may include homomorphically: generating an asset public key from a private key, generating an asset signature and/or performing a verification operation. Also, for example, the Southern Algorithm may include performing the verification operation. Additionally, for example, the verification operation may be implemented via an elliptical curve digital signature algorithm.

Embodiments may further comprise an apparatus, including one or more processors coupled to a memory to electronically generate one or more computationally verifiable smart contract templates substantially in accordance with at least layer 0 and/or layer 1 of one or more distributed network technologies. In implementations, the apparatus may implement any combination of aspects mentioned above in connection with the example process, for example.

Embodiments may also comprise an article comprising: a non-transitory storage medium having instructions stored thereon executable by a special purpose computing platform to electronically generate one or more computationally verifiable smart contract templates substantially in accordance with at least layer 0 and/or layer 1 of one or more distributed network technologies. Further, in implementations, the executable instructions may implement any combination of aspects mentioned above in connection with the example process, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic block diagram depicting an embodiment of an example system including one or more server computing devices and/or one or more IoT-type devices;

FIG. 2 is a schematic block diagram depicting an embodiment of an example Internet of Things (IoT)-type device;

FIG. 3 is a diagram depicting an example Taker wallet according to an embodiment;

FIG. 4 is a diagram depicting an example Maker wallet according to an embodiment;

FIG. 5 is an illustration depicting an example process for changing or modifying an implementation contract according to an embodiment;

FIG. 6 is a schematic block diagram depicting an example Tokenomics-type process (e.g., overview) according to an embodiment;

FIG. 7 is a schematic block diagram depicting an example agent process according to an embodiment;

FIG. 8 is a schematic block diagram showing one or more example contract systems processes (e.g., Contract Systems I) according to an embodiment;

FIG. 9 is a schematic block diagram showing one or more example contract systems processes (e.g., Contract Systems II) according to an embodiment;

FIG. 10 is a schematic block diagram depicting an example scheduling process according to an embodiment;

FIG. 11 is a schematic block diagram showing an example tokens release process according to an embodiment;

FIG. 12 depicts an example plot diagram showing example governance token allocation curves according to an embodiment;

FIG. 13 depicts a flow diagram illustrating an example process for initiating an on-line transaction according to an embodiment;

FIG. 14A is a flow diagram illustrating an example process for exchanging cryptographic assets between parties according to an embodiment;

FIG. 14B illustrates key-coding for example operations depicted in FIGS. 15-20 (e.g., exchange of assets between parties, etc.) according to an embodiment;

FIG. 15 depicts one or more example threshold shares and an example message according to an embodiment;

FIG. 16 depicts initially generated threshold homomorphic keypairs according to an embodiment;

FIG. 17 depicts initially generated threshold “′” homomorphic keypairs according to an embodiment;

FIG. 18 depicts a flow diagram illustrating an embodiment of an example process for validating a re-encryption key according to an embodiment;

FIGS. 19-20 depicts a flow diagram illustrating an embodiment of an example process for message validation and delivery;

FIG. 21 depicts an embodiment of an example N(orthern) Algorithm (N-Algo);

FIG. 22 depicts a flow diagram illustrating an embodiment of an example binary decomposition process;

FIG. 23 shows a flow diagram illustrating an embodiment of an example range check process;

FIG. 24 depicts a flow diagram illustrating an embodiment of an example bit check process;

FIG. 25 is a flow diagram depicting an embodiment of an example keypair generation process;

FIG. 26 provides flow diagrams illustrating an embodiment of an example ReEncryption operation and an embodiment of an example ReduceWithInternalMod operation;

FIG. 27 shows flow diagrams illustrating an embodiment of an example Decrypt operation and an embodiment of an example Decrypt2 operation;

FIGS. 28 and 29 depict schematic block diagrams illustrating an additional example implementation of a tokenomics platform according to an embodiment; and

FIG. 30 depicts a schematic diagram illustrating an implementation of an example computing environment according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. It should also be noted that “subject matter” and “claimed subject matter” can be used interchangeably herein.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

As mentioned, distributed computing and/or communications networks and/or associated technologies, which may include, for example, distributed ledger technologies (DLT) or the like (e.g., blockchain-type technologies, etc.) are becoming more and more prominent and may play an important role in the future of computing or like technology. These or like technologies may form, in whole or in part, one or more on-line community-driven platforms and/or systems, such as a foundation for digital or cryptocurrencies and/or various forms of cybersecurity technologies, for example. However, these or like technologies, including cryptocurrency or like technologies, for example, may pose significant challenges in promoting widespread adoption and/or implementation thereof, which may include, for example, relatively large utilization fees borne by users and/or due, at least in part, to technological hurdles faced by users trying to engage with and/or utilize such technologies. It should be noted that, even though the term “foundation” is used herein, such as for ease of discussion, any other suitable term or a combination thereof may be used, in whole or in part, to describe an on-line community-driven platform (e.g., decentralized, etc.) without deviating from the scope and/or spirit of the present disclosure.

As a way of illustration, in some circumstances, a user desiring to transact (e.g., purchase, sell, etc.) cryptocurrency may incur relatively large fees (e.g., so-called “gas fees,” etc.) that may discourage the user from participating in that market, platform, system, etc. Also, in some circumstances, users may be prompted to and/or required to go through a number of steps online to transact cryptocurrency. At least some of the steps involved may be relatively difficult to accomplish, particularly for those who may not be particularly technically proficient. And even for those who are technically proficient, the various steps and/or cost as well as complexity involved may be detriments to adoption and/or participation.

One or more embodiments described herein may include processes, devices, systems, etc. directed to addressing these or like challenges, among other challenges, as will be seen. For example, one or more embodiments may be implemented, at least in part, to facilitate reducing costs for users and/or to reducing technological complexities that may make it more difficult for users to engage with such technologies. As one particular example, one or more embodiments may be directed to reducing costs of so-called “atomic swaps” or exchanges of cryptocurrencies from one or more platforms, blockchains, sidechains, etc. and/or may be directed to making cryptocurrency technologies, for example, easier to use and/or experience. Thus, one or more embodiments described herein may, for example, promote more widespread adoption of these or like technologies.

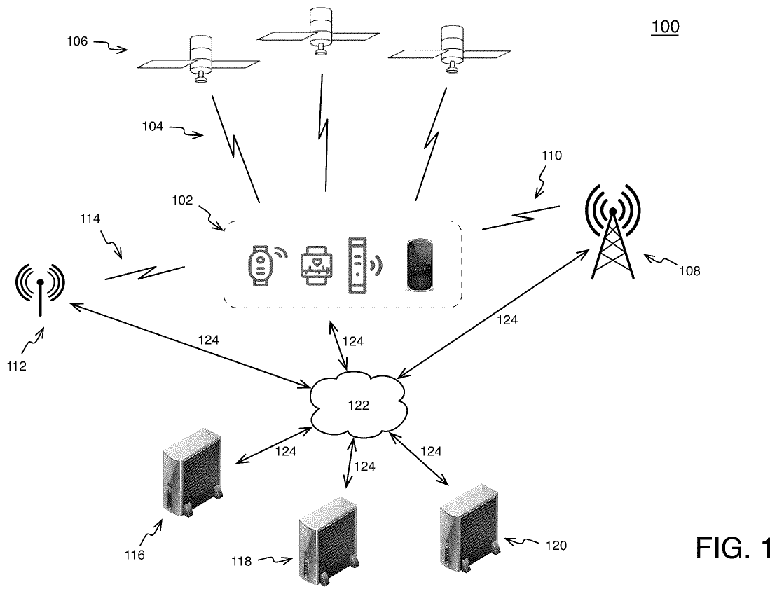

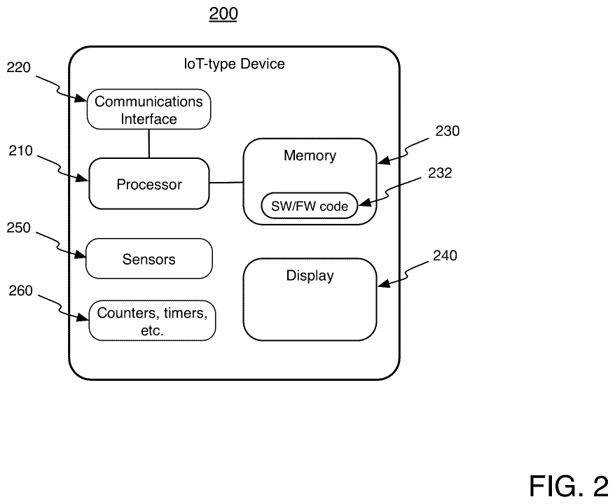

Even though a number of particular implementations are described herein, it should be noted, however, that subject matter is not limited in scope to the particular example implementations provided. Also, example implementations may utilize, at least in part, any of a wide range of computing and/or communication devices, systems, components, technologies, networks, etc. The discussion below, including aspects related to FIGS. 1 and 2, for example, describes various aspects of an example infrastructure that may facilitate and/or support, at least in part, one or more example implementations discussed herein.

As alluded to previously, the “World Wide Web” or simply the “Web,” such as provided by the Internet, for example, is growing rapidly, at least in part, from the large amount of content being added seemingly on a daily basis. A wide variety of content in the form of stored signals, such as, for example, text files, images, audio files, video files, web pages, measurements of physical phenomena, and/or the like may be continually acquired, identified, located, retrieved, collected, stored, communicated, etc. Increasingly, content is being acquired, collected, communicated, etc. by a number of electronic devices, such as, for example, embedded computing devices leveraging existing Internet and/or like infrastructure as part of a so-called “Internet of Things” (IoT), such as via a variety of protocols, domains, and/or applications. IoT may typically comprise a system of interconnected and/or internetworked physical computing devices capable of being identified, such as uniquely via an assigned Internet Protocol (IP) address, for example. Devices, such as IoT-type devices, for example, may include computing resources embedded into hardware so as to facilitate and/or support a device's ability to acquire, collect, process and/or transmit content over one or more communications networks. In this context, “IoT-type devices” and/or the like refer to one or more electronic and/or computing devices capable of leveraging existing Internet and/or like infrastructure as part of the IoT, such as via a variety of applicable protocols, domains, applications, etc. In particular implementations, IoT-type devices, for example, may comprise a wide variety of embedded devices, such as, for example, automobile sensors, biochip transponders, heart monitoring implants, thermostats, kitchen appliances, locks or like fastening devices, solar panel arrays, home gateways, controllers, etc. and even mobile devices, desktop computers, laptop computers, and/or the like. Although embodiments described herein may refer to IoT-type devices, subject matter is not limited in scope in these respects. For example, although IoT-type devices may be described, such as for ease of discussion, it should be noted that subject matter is intended to include use of any of a wide range of electronic device types, including a wide range of computing and/or communications device types.

“Electronic content,” “digital content,” “content,” and/or the like as the terms are used herein should be interpreted broadly and refers to signals, such signal packets, for example, and/or states, such as physical states on a memory device, for example, but otherwise are employed in a manner irrespective of format, such as any expression, representation, realization, and/or communication, for example. Content may comprise, for example, any information, knowledge, and/or experience, such as, again, in the form of signals and/or states, physical or otherwise. In this context, “electronic” or “on-line” content refers to content in a form that although not necessarily capable of being perceived by a human, (e.g., via human senses, etc.) may nonetheless be transformed into a form capable of being so perceived, such as visually, haptically, and/or audibly, for example. Non-limiting examples may include text, audio, images, video, security parameters, combinations, or the like. Thus, content may be stored and/or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, data, metadata, message, text, audio file, video file, data file, web page, or the like. Claimed subject matter is not intended to be limited to these particular examples, of course.

FIG. 1 is a schematic diagram illustrating features associated with an implementation of an example operating environment 100 capable of facilitating and/or supporting one or more operations and/or techniques for computationally verifiable smart-contract-type infrastructure for distributed computing and/or communications networks, illustrated generally herein at 102. As was indicated, one or more operations and/or techniques may, for example, be implemented. At least in part, in connection with one or more IoT-type devices, though subject matter is not so limited. Briefly, IoT is typically a system of interconnected and/or internetworked physical devices in which computing may be embedded into hardware so as to facilitate and/or support devices' abilities to acquire, collect and/or communicate content over one or more communications networks, for example, at times, without human participation and/or interaction. As mentioned, IoT-type devices may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet or other personal computers (PCs), personal audio and/or video devices, personal navigation devices, mobile devices, and/or the like.

It should be appreciated that operating environment 100 is described herein as a non-limiting example that may be implemented, in whole or in part, in a context of various wired and/or wireless communications networks and/or any suitable portion and/or combination of such networks. For example, these or like networks may include one or more public networks (e.g., the Internet, the World Wide Web), private networks (e.g., intranets), wireless wide area networks (WWAN), wireless local area networks (WLAN, etc.), wireless personal area networks (WPAN), telephone networks, cable television networks, Internet access networks, fiber-optic communication networks, waveguide communication networks and/or the like. It should also be noted that claimed subject matter is not limited to a particular network and/or operating environment. Thus, for a particular implementation, one or more operations and/or techniques for computationally verifiable smart-contract-type infrastructure for distributed computing and/or communications networks may be performed, at least in part, in an indoor environment and/or an outdoor environment, or any combination thereof.

Thus, as illustrated, in a particular implementation, one or more computing and/or communications devices, such as IoT-type devices 102 may, for example, receive and/or acquire satellite positioning system (SPS) signals 104 from SPS satellites 106. In some instances, SPS satellites 106 may be from a single global navigation satellite system (GNSS), such as the GPS or Galileo satellite systems, for example. In other instances, SPS satellites 106 may be from multiple GNSS such as, but not limited to, GPS, Galileo, Glonass, or Beidou (Compass) satellite systems, for example. In certain implementations, SPS satellites 1006 may be from any one several regional navigation satellite systems (RNSS) such as, for example, WAAS, EGNOS, QZSS, just to name a few examples.

At times, one or more IoT-type devices 102 may, for example, transmit wireless signals to and/or receive wireless signals from a suitable wireless communication network. In one example, one or more IoT-type devices 102 may communicate with a cellular communication network, such as by transmitting wireless signals to and/or receiving wireless signals from one or more wireless transmitters capable of transmitting and/or receiving wireless signals, such as a base station transceiver 108 over a wireless communication link 110, for example. Similarly, one or more IoT-type devices 102 may transmit wireless signals to and/or receive wireless signals from a local transceiver 112 over a wireless communication link 114, for example. Base station transceiver 108, local transceiver 112, etc. may be of the same or similar type, for example, and/or may represent different types of devices, such as access points, radio beacons, cellular base stations, femtocells, an access transceiver device, or the like, depending on an implementation. Similarly, local transceiver 112 may comprise, for example, a wireless transmitter and/or receiver capable of transmitting and/or receiving wireless signals. For example, at times, wireless transceiver 112 may be capable of transmitting and/or receiving wireless signals from one or more other terrestrial transmitters and/or receivers.

In a particular implementation, local transceiver 112 may, for example, be capable of communicating with one or more IoT-type devices 102 at a shorter range over wireless communication link 114 than at a range established via base station transceiver 108 over wireless communication link 110. For example, local transceiver 112 may be positioned in an indoor or like environment and/or may provide access to a wireless local area network (WLAN, e.g., IEEE Std. 802.11 network, etc.) and/or wireless personal area network (WPAN, e.g., Bluetooth® network, etc.). In another example implementation, local transceiver 112 may comprise a femtocell and/or picocell capable of facilitating communication via link 114 according to an applicable cellular or like wireless communication protocol. Again, it should be understood that these are merely examples of networks that may communicate with one or more IoT-type devices 102 over a wireless link, and claimed subject matter is not limited in this respect. For example, in some instances, operating environment 100 may include a larger number of base station transceivers 108, local transceivers 112, networks, terrestrial transmitters and/or receivers, etc.

In an implementation, one or more IoT-type devices 102, base station transceiver 108, local transceiver 112, etc. may, for example, communicate with one or more servers, referenced herein at 116, 118, and 120, over a network 122, such as via one or more communication links 124. It should be noted that, depending on an implementation, one or more servers 116, 118, and/or 120 may be part of a centralized network, a decentralized network, or any combination thereof. Thus, even though terms like “server” or “servers' are used herein, such as for ease of discussion, it should be appreciated that these or like aspects may include and/or be part of one or more centralized and/or decentralized networks. Thus, as indicated, network 122 may comprise, for example, a centralized network, a decentralized network, or any combination thereof, and may include any number and/or combination of wired and/or wireless communication links. In a particular implementation, network 122 may comprise, for example, Internet Protocol (IP)-type infrastructure capable of facilitating or supporting communication between one or more IoT-type devices 102 and one or more servers 116, 118, 120, etc. via local transceiver 112, base station transceiver 108, directly, etc. In another implementation, network 122 may comprise, for example cellular communication network infrastructure, such as a base station controller and/or master switching center to facilitate and/or support mobile cellular communication with one or more IoT-type devices 102. Servers 116, 118 and/or 120 may comprise any suitable servers or combination thereof capable of facilitating or supporting one or more operations and/or techniques discussed herein. For example, servers 116, 118 and/or 120 may comprise one or more update servers, back-end servers, management servers, archive servers, location servers, positioning assistance servers, navigation servers, map servers, crowdsourcing servers, network-related servers, or the like.

Even though a certain number of computing platforms and/or devices are illustrated herein, any number of suitable computing platforms and/or devices may be implemented to facilitate and/or support one or more techniques and/or processes associated with operating environment 100. For example, at times, network 122 may be coupled to one or more wired and/or wireless communication networks (e.g., WLAN, etc.) so as to enhance a coverage area for communications with one or more IoT-type devices 102, one or more base station transceivers 108, local transceiver 112, servers 116, 118, 120, or the like. In some instances, network 122 may facilitate and/or support femtocell-based operative regions of coverage, for example. Again, these are merely example implementations, and claimed subject matter is not limited in this regard.

In this context, “IoT-type devices” refer to one or more electronic and/or computing devices capable of leveraging existing Internet or like infrastructure as part of the so-called “Internet of Things” or IoT, such as via a variety of applicable protocols, domains, applications, etc. As was indicated, the IoT is typically a system of interconnected and/or internetworked physical devices in which computing may be embedded into hardware so as to facilitate and/or support devices' ability to acquire, collect, and/or communicate content over one or more communications networks, for example, at times, without human participation and/or interaction. IoT-type devices 102, for example, may include a wide variety of stationary and/or mobile devices, such as, for example, automobile sensors, biochip transponders, heart monitoring implants, kitchen appliances, locks or like fastening devices, solar panel arrays, home gateways, smart gauges, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, mobile devices, stationary devices, and/or the like, to name a few non-limiting examples. Typically, in this context, a “mobile device” refers to an electronic and/or computing device that may from time to time have a position or location that changes, and/or a “stationary device” refers to an electronic and/or computing device that may have a position or location that generally does not change. In some instances, IoT-type devices, such as IoT-type devices 102, may be capable of being identified, such as uniquely, via an assigned Internet Protocol (IP) address (e.g., static, dynamic, etc.), as one particular example, and/or having an ability to communicate, such as receive and/or transmit electronic content, for example, over one or more wired and/or wireless communications networks.

It may again be noted that the example infrastructure discussed above, along with additional systems, apparatuses, processes, etc., discussed herein, may be directed, at least in part, to supporting computationally verifiable smart-contracts and/or may be directed at least in part to reducing costs of atomic swaps or exchanges of cryptocurrencies from one or more platforms, blockchains, sidechains, etc. The example infrastructure discussed above, along with additional systems, apparatuses, processes, etc., discussed herein, may be further directed, at least in part, to making cryptocurrency technologies, for example, easier to use and/or experience, thus helping to promote more widespread adoption of these or like technologies.

FIG. 2 is an illustration of an embodiment 200 of an example particular IoT-type device. Of course, subject matter is not limited in scope to the particular configurations and/or arrangements of components depicted and/or described for example devices mentioned herein. In an embodiment, an IoT-type device, such as 200, may comprise one or more processors, such as processor 210, and/or may comprise one or more communications interfaces, such as communications interface 220. In an embodiment, one or more communications interfaces, such as communications interface 220, may enable wireless and/or wired communications between an electronic device, such as an IoT-type device 200, and one or more other computing devices. In an embodiment, wireless and/or wired communications may occur substantially in accordance any of a wide range of communication protocols, such as those known and/or mentioned herein, for example, and/or developed in the future.

In a particular implementation, an IoT-type device, such as IoT-type device 200, may include a memory, such as memory 230. In a particular implementation, memory 230 may comprise a non-volatile memory, for example. Further, in a particular implementation, a memory, such as memory 230, may have stored therein executable instructions, such as for one or more operating systems, communications protocols, and/or applications, for example. A memory, such as 230, may further store particular instructions, such as software and/or firmware code 232, that may be updated via one or more example implementations and/or embodiments described herein. Further, in a particular implementation, an IoT-type device, such as IoT-type device 200, may comprise a display, such as display 240, and/or one or more sensors, such as one or more sensors 250. As utilized herein, “sensors” and/or the like refer to a device and/or component that may respond to physical stimulus, such as, for example, heat, light, sound pressure, magnetism, particular motions, etc., and/or that may generate one or more signals and/or states in response to physical stimulus. Example sensors may include, but are not limited to, one or more accelerometers, gyroscopes, thermometers, magnetometers, barometers, light sensors, proximity sensors, hear-rate monitors, perspiration sensors, hydration sensors, breath sensors, cameras, microphones, etc., and/or any combination thereof.

In particular implementations, IoT-type device 200 may include one or more timers and/or counters and/or like circuits, such as circuitry 260, for example. In an embodiment, one or more timers and/or counters and/or the like may track one or more aspects of device performance and/or operation. For example, timers, counters, and/or other like circuits may be utilized, at least in part, by IoT-type device 200 to determine measures of fitness, for example, and/or to otherwise generate feedback content related to testing results, in particular implementations.

Although FIG. 2 depicts a particular example implementation of an IoT-type device, such as IoT-type device 200, other embodiments may include other types of electronic and/or computing devices. Example types of electronic and/or computing devices may include, for example, any of a wide range of digital electronic devices, including, but not limited to, cellular telephones (e.g., smartphones), tablet devices, desktop and/or notebook computers, virtual and/or augmented reality devices, high-definition televisions, digital video players and/or recorders, game consoles, satellite television receivers, wearable devices, personal digital assistants, mobile audio and/or video playback and/or recording devices, streaming devices, or any combination of the foregoing. Of course, subject matter is not limited in scope in these respects.

As mentioned, in some instances, it may be advantageous to reduce costs for users and/or to reduce technological complexities that may make it more difficult for users to engage with distributed network technologies and/or the like. For example, in some circumstances, a user desiring to purchase cryptocurrency may incur relatively large fees that may discourage the user from participating in that platform, market, network, etc. As just one example, Ethereum “gas fees” may comprise transaction fees paid by users and/or provided to miners. “Miners” and/or the like in this context refers to individuals providing computational resources to add transactions to one or more existing blockchains, sidechains, etc., for example. Thus, users may incur relatively large fees, such as gas fees, in performing cryptocurrency or other on-line transactions, for example.

Also, in some circumstances, users may be required to go through a number of steps online to transact, such as purchase, sell, etc. cryptocurrency, for example. At least some of the steps involved may be relatively difficult to accomplish, particularly for those who may not be particularly technically proficient. As mentioned, even for those who are technically proficient, the various steps involved can be detriments to adoption and/or participation.

To address, at least in part, these or like challenges, one or more embodiments discussed herein may be directed to reducing costs for users and/or may be directed to reducing technological complexities that may make it more difficult for users to engage with blockchain or other like technologies and/or networks, for example. Embodiments may be directed to providing users an experience aligned with what users might normally experience in on-line transactions (e.g., purchases, etc.) while providing users the advantages of decentralized currencies, such as cryptocurrencies, for example.

For example, as was indicated, one or more embodiments may be directed to reducing costs of atomic swaps and/or may be directed to making cryptocurrency technologies, for example, easier to use and/or experience. “Atomic swap” and/or the like refers to an exchange of cryptocurrency from one or more platforms, systems, networks, etc. Thus, one or more embodiments described herein may promote more widespread adoption of these or like technologies. In some instances, these technologies may include blockchain or like technologies, though subject matter is not so limited.

For example, IoT-type device 200 and/or the like may support computationally verifiable smart-contracts and/or may include aspects directed to reducing costs of atomic swaps or exchanges of cryptocurrencies from one or more platforms, blockchains, sidechains, etc. In implementations, IoT-type device 200 may promote more widespread adoption of cryptocurrency technologies and/or the like by making such technologies easier and/or more enjoyable to use and/or experience at least in part by incorporating one or more aspects of the various systems, apparatuses, processes, etc., discussed herein.

By way of background, it may be noted that blockchain technologies may be partitioned, literally and/or figuratively, into layers. For example, “layer 0” and/or the like may refer to the infrastructure required to support cryptocurrencies such as Bitcoin, Ethereum, etc. and/or other blockchain networks, for example. Layer 0 components may include, for example, the Internet, hardware, and/or connections that may enable operations of Layer 1. “Layer 1” and/or the like may sometimes be referred to as an implementation layer. Layer 1 may comprise a base layer that relies on its immutability for security. For example, when people say the “Ethereum network,” they are typically, although not necessarily, referring to Layer 1. Layer 1 may be responsible for consensus mechanisms, computing language, block time, dispute resolution, and/or rules and/or parameters that may ensure or facilitate the base-level functionality of a blockchain network, for example. “Layer 2” and/or the like may refer to overlapping networks that sit on top of the base layer(s). Protocols may make use of layer 2 to increase scalability by removing some interactions from the base layer. As a result, smart contracts on a primary blockchain protocol may deal with deposits and withdrawals, for example, and/or may ensure that off-chain transactions follow regulations, just to illustrate a few examples. Bitcoin's Lightning Network is an example of a layer 2 blockchain. For example, the blockchain may comprise a first layer in a decentralized ecosystem. Layer 2 may comprise a third-party integration used in conjunction with layer 1 to enhance the number of nodes and, as a result, system throughput.

Current ERC (Ethereum) token standards (e.g., 884, 777, 20, etc.), for example, may comprise smart contracts with relatively expensive gas fees to incentivize miner validation and/or execution of contract contents. Higher gas fees, for example, may cause frustration for users and may discourage participation in cryptocurrency or like markets. Embodiments described herein may allow for substantially and/or radically inexpensive gas fee atomic swaps, for example. In implementations, liquidity may be provided via a service layer ecosystem that may reward stakers and/or liquidity providers with interest on their staked coins, such as in the form of a Bitcoin SV (BSV), Solana, and/or ERC20 wrapped utility token, for example, and the remainder in transaction fees. This may be accomplished, in an implementation, via leveraging the unique technological and pricing superiority of BSV, Solana, Algorand, DERO, and/or Constellation networks, to name a few non-limiting examples. It has been observed that, at times, Ethereum based Layer 2 solutions, for example, have failed conclusively thus far for poor usability and platform reasoning. Thus, one or more operations and/or techniques discussed herein may present an advantageous technological arbitrage opportunity that may provide a statistically significant (e.g., 10×, etc.) cost reduction, for example.

As mentioned above, one or more embodiments may be directed to reducing costs of atomic swaps and/or may be directed to making cryptocurrency technologies easier to use and/or experience, for example. As will also be seen, in some instances, one or more embodiments may also seek to achieve a decentralized crypto exchange (DEX) and/or associated software development kit (SDK), plus one or more wallets to house logic, provide interfaces, etc. “DEX” and/or the like may refer to blockchain-type applications that may coordinate larger-scale trading of crypto assets between and/or among a number of users, for example.

As discussed herein, to facilitate and/or support one or more operations and/or techniques discussed herein, a Taker and a Maker aspects may be employed, in whole or in part. For example, if one person wants to “take” a trade and the other person wants to “make” the market (or provide liquidity, for example) one should reward the person providing liquidity because they're taking the risk. This may be similar to the sort of trading mechanics across really any financial market. The person making the market is taking the risk generally and the person who's taking the market is generally offloading risk and is willing to pay a premium to do so. As utilized herein, “Maker” and/or “Taker” may refer to users participating one with another in a cryptocurrency or other suitable transaction. For example, as mentioned, a Taker may wish to take a trade and a Maker may make the market for the trade and/or to provide liquidity.

In some circumstances, in crypto, there may be no rewards for being a market maker. There are some DEX that tried to tackle the problem. That's kind of what indexes hoped to do, but they haven't really been able to do it effectively.

Examples described herein may refer to or be described in connection with Ethereum (ETH) and Bitcoin (BTC), though, again subject matter should not be so limited. For example, BTC may have relatively lower fees and/or plenty data transmission capabilities versus ETH which may have relatively higher fees (e.g., relatively very high gas fees). Again, although ETH and/or BTC are particularly mentioned, subject matter is not limited in scope in these respects. Rather, embodiments may be utilized with a wide range of blockchain or other technologies and/or the like.

Thus, embodiments may include the use of “Maker” and/or “Taker” templates, such as implemented via one or more smart contract processes, for example. In implementations, a Maker template may be designed and/or provided, for example, which may comprise a template for a smart contract using layer 0 and/or layer 1 technologies and/or mechanics that may validate itself, at least in part. A Maker template may be computationally verifiable, but independent of a particular blockchain or another distributed network and/or platform. In implementations, a Maker template may be deployed anywhere to any network. Thus, even though “blockchain” or like terms are used throughout, such as for ease of discussion, it should be noted that these or like terms may refer to other distributed and/or decentralized networks (e.g., InterPlanetary File System, a directed acyclic graph, Hyperledger, holochain, Radix(Tempo), etc.).

Maker and Taker Wallets:

In implementations, a Taker template may assign a cryptographic protocol that a Taker smart contract implementation may, on any particular blockchain, follow and get the same exact result. In implementations, a Maker template may do the same thing, at least in part.

Parent and child identifying entities (e.g., contracts, addresses, wallets, shards, or other such identifying blockchain data structures) may be generated in BSV, for example, and exchanged as “puzzles”. These may be referred to as parent and child Network ID's, and may be BSV specific, for example. In implementations, Hierarchical Deterministic Wallets (HD wallets) may be utilized, for example. HD wallets, although introduced by the Bitcoin community, may comprise a wallet structure that supports many coins. HD wallets may allow for an entire suite of crypto-wallets to be generated from a single seed phrase, for example. Also, for example, an HD wallet may comprise a public/private key tree all starting from a root node (master node).

In implementations, a user interface (UI) may include characteristics similar in at least some aspects to an Atomic Cryptocurrency Wallet, for example. For example, a UI, such as may be executed on a mobile device, may comprise a non-custodial decentralized wallet (e.g., users own their own backup phrase and/or private keys and thus control their funds). Also, for example, master keys (e.g., provided upon first installation of wallet) and/or private keys may be stored locally on the mobile device and/or may be strongly encrypted. Also, for example, funds are not located in the wallet itself, but are safely stored on the blockchain. In an implementation, a UI may allow for the wallet to connect directly to the blockchain nodes and/or may show information about balances, transaction history and/or other content. A UI may also allow users to perform transactions on the blockchain, for example.

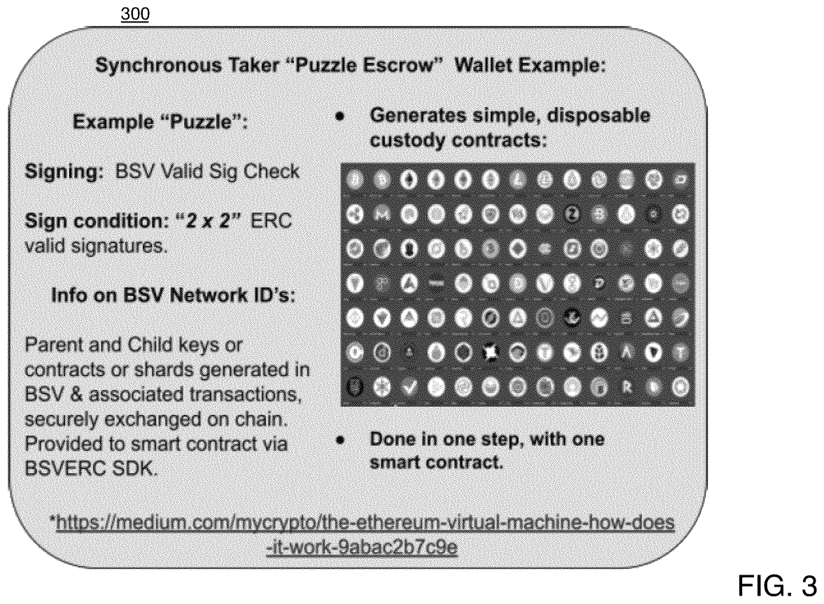

Taker Template (See FIG. 3, for Example)

In an implementation, a taker template 300 may comprise a 2×2 multi-signature smart contract template stored in or referenceable by the SDK. A taker template may be dynamically instantiated and/or may be dynamically instantiated synchronously. Protocol examples may use HD Wallets in BSV for Network IDs, for example. In implementations, keyless network ID management can be utilized. A taker template may require passing signature checks by ERC token private keys (e.g., of the same token type as the Taker's tokens) generated by the Maker and Taker as a condition to spend. In protocol implementations featuring reusable wallets, care may be taken to avoid signature replay vulnerabilities. As an additional spend condition, a taker template may implement and/or require the validation of a cross chain hash-timelock contract (HTLC) between Ethereum (ETH) and BSV chains, for example. This validation is a signature check that accepts additional (e.g., two) parameters than a “traditional” contract spend function. The check may be performed by a validation function, which is the “puzzle” portion of the “puzzle escrow.” It may require two valid signatures of two signals indicating “transaction completion”, one using the Maker BSV child Network ID (e.g., as may be established in a simplified payment verification (SPV) aspect of an example exchange methodology in accordance with particular implementations), and the other the Taker's (respectively), for example. In implementations, a signal may simply comprise a protocol standardized message indicating successful or failed transfer of the ERC token keys (transaction completion) between Maker and Taker broadcasted on the BSV chain from their child network IDs. The timestamps may be no more than 5 minutes after the funding and subsequent deployment of the Taker smart contract to pass the validation check, even with valid signatures, for example. Failure to locate these two signals on the BSV chain upon calling the spend function may result in the Taker multi-signature contract requiring the Taker's signature to approve a spend, in an implementation.

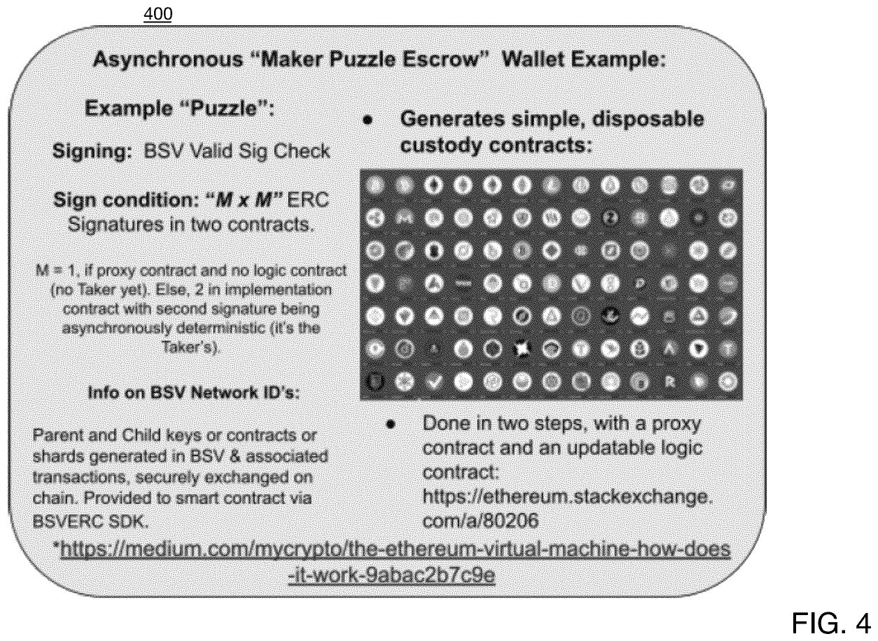

Maker Template (See FIG. 4, for Example)

In implementations, a Maker template 400 may comprise a 2×2 multi-signature smart contract template stored in or referenceable by an SDK. A Maker template may be dynamically instantiated synchronously as the first and ONLY allowable update to the Maker's asynchronous 1×1 Implementation smart contract, for example. Protocol examples could use HD Wallets in BSV for Network IDs, for example. In other implementations, keyless Network ID management may be implemented. A Maker template may require passing signature checks by the ERC token private keys (of the same token type as the Maker's tokens), for example, generated by the Maker and Taker as a condition to spend. It may comprise spend and/or “reset” public methods, for example. In protocol implementations featuring reusable wallets, care may be taken to avoid signature replay vulnerabilities. As an additional spend condition, for example, a Maker template may implement and/or require validation of a cross chain HTLC between ETH and BSV chains, in an implementation. This validation may comprise a signature check that may accept additional parameters (e.g., two additional parameters) than a “traditional” contract spend function. The check may be performed by a validation function, which may comprise the “puzzle” portion of the “puzzle escrow”. If called with two signature parameters, for example, it may require two valid signatures of two signals indicating “transaction completion”, one using the Maker BSV child Network ID (established in an SPV portion of an exchange methodology), and the other the Taker's respectively. In implementations, a signal may simply comprise a protocol standardized message indicating successful or failed transfer of the ERC token keys (transaction completion), for example, between Maker and Taker broadcasted on the BSV chain from their child network IDs. The timestamps may be no more than 5 minutes after the funding and subsequent deployment of the Taker smart contract to pass the validation check, even with valid signatures, for example. Failure to locate or validate these two signals on the BSV chain upon calling the spend function may result in the Maker multi-signature contract requiring only the Maker's signature to approve a spend, in an implementation. Alternatively, calling the reset function with the Maker's signature in the spend function triggers the validation function with one signature, for example. Upon validation success, the reset method spends Maker gas to return control of an implementation contract (e.g., v1 implementation contract) back to the Maker's child Network ID in a contract update, in an implementation.

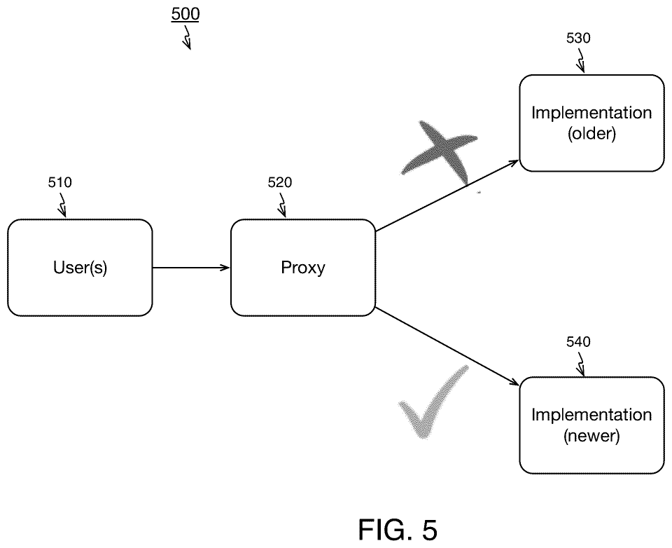

FIG. 5 is an illustration depicting an example process 500 for changing or modifying an implementation contract according to an embodiment. Example process 500 depicts user(s) 510 and a proxy contract 520 having an older implementation 530 updated with a newer implementation 540. Of course, subject matter is not limited in scope to the particular details of example process 500. Additional aspects of example process 500 are discussed below, along with additional material. It should be noted, of course, that subject matter is not limited in scope in these respects.

SDK:

In implementations, an SDK may comprise a relatively lighter-weight smart contract and/or protocol implementor and/or blockchain content fetcher. An SDK may manage the BSV master addresses, shards, contracts, etc. (e.g., BSV Network IDs) and/or may manage procedurally generated child versions. Children may be used for anonymously signing and/or funding, for example. In an implementation, the SDK may dynamically generate Maker and/or Taker smart contracts (e.g., ERC Maker and Taker smart contracts) using embedded, public templates, for example. A variety of tools, such as non-limiting examples, mAPI, BSV v1.0.6, and/or SPV 1.0.0, may be utilized to design and/or implement an SDK, in implementations.

Exchange Methodology:

The example protocol and/or process described below is merely an example, and subject matter is not limited in scope in these respects. Embodiments may include all of the operations described, fewer than the operations described, and/or more than the operations described. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

The methodology of an example protocol and/or process may proceed in a number of operations, generally as follows.

1. In an implementation, a market maker (“Maker”) may indicate a desire to fund a Maker wallet with tokens the Maker may wish to earn interest on and thus may provide swapping liquidity for a network, for example. The Maker may also choose to earn an annual percentage yield (APY) and not participate in swapping, becoming a liquidity provider in the service layer, for example. A Maker wallet may be used by a DEX to swap particular tokens for others in the market and/or may be generated asynchronously, in an implementation.

2. In an implementation, funding indication may trigger creation of a Maker token ERC signing address by Maker's SDK.

3. In an implementation, Maker SDK may initiate “upgradable” Maker wallet templates (e.g., (Proxy and/or Implementation), perhaps in the style of Open Zeppelin, for example. See, for example, FIG. 5, depicting user(s) 510 and a proxy contract 520 having an older implementation 530 updated with a newer implementation 540. The proxy (ERC) contract may be controlled by the Maker, and may reference the implementation contract for which M=1, for example. The implementation ERC contract likewise, and may have a nonce field of “x”. A 1×1 address may comprise the signing address from operation 2, in an implementation.

4. In an implementation, the Maker's SDK (e.g., via the BSV parent network ID and/or built-in BSV tooling) may use the parent ID to generate a child ID in anticipation of a future implementation contract upgrade and/or ownership transfer of ETH keys, for example.

5. In an implementation, Maker may fund the proxy smart contract by transferring funds into it. The Maker may indicate what exchange pairs the Maker would like to exchange their wallet funds for, for example.

6. In an implementation, some time may pass and a “Taker” may signal the DEX (e.g., via the Taker SDK) an intent to perform an atomic swap for the tokens/coins they possess.

7. In an implementation, the Taker SDK may check whether the exchange pair can be performed using the available “Maker” liquidity in the DEX. If so, proceed to operation 10, and/or if not proceed to operation 8, in an implementation.

8. In an implementation, If DEX cannot locate the desired exchange pair, the DEX may signal the service layer for liquidity partner support. Liquidity partners may have their Maker funds swapped for equivalent value tokens, for example. The new Maker funds may be utilized to facilitate the trade by the DEX, in an implementation. In an implementation, if no liquidity partners are found within a specified time period (e.g., two minutes), proceed to operation 9. Otherwise, for example, if liquidity partners are found within the specified time period, proceed to operation 10.

9. In an implementation, the Taker may be offered an opportunity to become a Maker with an increased APY by the DEX. If the Taker declines, the example process may return to operation 6 or may terminate per the Taker's choice, for example.

10. On successful exchange pairing, the DEX may signal the SDK to initiate the exchange between Maker and Taker, in an implementation. The Maker SDK may establish a communication channel (e.g., websocket, SSL connection, events hook, etc.) with the Taker SDK, for example. It may share details of the Proxy and current Implementation smart contracts with the Taker SDK, in an implementation.

11. In an implementation, Taker SDK may generate multiple (e.g., two) ERC token signing addresses. One for the Maker token, and one for the Taker token, for example.

12. In an implementation, the Taker SDK may signal to the Maker SDK to asynchronously initialize upgrade and/or ownership transfer of implementation smart contract to a multi-signature upgrade version of the implementation smart contract (e.g., in a single step). In an implementation, a multi-signature (or multisig) contract may comprise a contract that may execute arbitrary transactions with a restriction that a particular number of owners agree upon them, for example.

13. In an implementation, the Maker SDK may generate an ERC token signing address, for example, for the Taker token.

14. In an implementation, Maker and Taker SDKs may exchange ERC signing public keys generated during the protocol, for example. Maker's signing address in operation 2 should have been exchanged. If not, the exchange may take place at this point, for example.

15. In an implementation, Taker SDK may anonymously generate a disposable child BSV Network ID from parent BSV Network ID. For example, in protocol implementations where Network IDs are BSV wallet addresses and associated private keys, following BIP 32 for HD wallets, for example, the child credentials may be generated via hardened parent credentials in an HD wallet generation procedure, in an implementation. In other implementations this may be done through secure multi-party computation (MPC).

16. In an implementation, the Taker SDK may pass the public portion of the ID it generated in operation 15 to the Maker SDK, for example.

17. In an implementation, the Taker SDK may then dynamically generate a 2×2 ERC multi-signature smart contract for their token, using a “Taker template,” which may be standardized, for example. The Maker SDK, continuing the example process outlined in operation 12, may simultaneously dynamically generate an upgraded 2×2 multi-signature version of the implementation contract for their token (recall that this may, too, exist on the ETH chain), for example. This nonce is updated to “x+1”. The details of the contract may utilize a “Maker Template,” which may be standardized, for example.

18. In an implementation, the Maker SDK may finalize and deploys the update from operation 17 as a separate contract and/or may transfer control of the first implementation contract to the updated implementation contract. Upon completion, notification of the Taker's SDK with protocol relevant variables and/or content may occur, in an implementation.

19. In an implementation, the Taker SDK may verify these changes using Maker SDK content as follows, for example: a check to ensure the proxy balance remains unchanged; a check to ensure that the proxy contract still references “version 1” (nonce=x) of the implementation contract; and/or a check to ensure that “version 1” (nonce=x) of the implementation contract has successfully transferred control of the spending to the “version 2” (nonce=x+1) multi-signature contract. In an implementation, upon failure of any of the above conditions, the Taker SDK may abort the protocol implementation and/or may notify the Maker SDK. In an implementation, the Maker may access their funds again after a specified period of time (e.g., 5 minutes), even in the absence of notification, for example, by calling a reset function in the Maker puzzle escrow contract (e.g., implementation contract version 2). Upon successful verification, the Taker's SDK may prompt the Taker to fund and deploy their smart contract by the SDK, for example.

20. In an implementation, the Taker has a specified period of time (e.g., 5 minutes) to fund and deploy their smart contract, then communicate this to the Maker SDK. The Maker may verify this, in an implementation.

21. In an implementation, the Maker and Taker SDKs may utilize the child network IDs previously generated to establish SPV channels on BSV, for example. In an implementation, they may then exchange their respective tokens' signing address private key. For example, the Taker may send over their generated ERC signing address private key for the token they want to exchange with. The Maker may do the same, for example.

22. In an implementation, the Maker and Taker SDKs may verify the ETH keys, for example, by generating signatures with them then performing signature checks and/or or perhaps by examining compositions of shared secret keys in elliptic curve digital signal algorithm (ECDSA), for example. In an implementation, this operation may be dependent, at least in part, on the ETH network's current implementation, although subject matter is not limited in scope in this respect.

23. In an implementation, the first successful verification by an SDK may cause that SDK to transmit its child network ID's private info/key across the SPV channel to the counterparty. It then may wait for the counterparty's child network ID private info/key. If it receives it, it may verify the ID by generating a BSV signature and verifying the signature, for example. If a specified period of time (e.g., 5 minutes) from the Taker wallet being deployed and funded has elapsed and it has NOT received it, the Taker's escrow puzzle smart contract becomes spendable with their signature alone, and the Maker's can call a reset process and simply spend from there, in an implementation.

24. In an implementation, responsive at least in part to both parties successfully sending their full, valid child network ID data through the SPV, both parties' SDKs may submit a “Success” signal using the other party's child network ID public and private data (e.g., as quickly as possible) on the BSV chain, for example. The SDKs may communicate through the SPV the signals Tx Hash and/or other relevant information to be used when calling their spend functions and/or closing the SPV channel and/or ending SDK channel communication, in an implementation.

In implementations, “quantum proof” security may be applied to blockchain swaps using Fully Homomorphic Encryption (FHE), for example. “Quantum-proof” and/or the like (sometimes referred to as post-quantum cryptography, quantum-safe or quantum-resistant) refers to cryptographic algorithms (e.g., public-key algorithms) that are thought to be safe against cryptanalytic attack by a quantum computer. Of course, other security/encryption schemes may also be utilized in implementations. The same encryption may be utilized in a smart contract on any “suitable” chain that may be selected for particular implementations. For example, the functionality of the Maker and Taker contracts may be moved to the example chains mentioned above (e.g., Solana, BSV, DERO, Algorand, Constellation, etc.) because, at least in part, they may be suitable for particular implementations. For example, “suitable” blockchains may comprise particular properties: 1) Turing completeness (or near Turing completeness); 2) Inexpensive transaction fees (e.g., affordable for the average consumer in a third world country); and/or 3) Fast settlement times (e.g., zero confirmations, near instant confirmation times, etc.). In this manner, a simplified interface may be provided for the example complex models mentioned above in a neat, simple to validate manner, in implementations.

Tokenomics Guide (for Purposes of Explanation)

The example protocols and/or processes described herein are merely examples, and subject matter is not limited in scope in these respects. Embodiments may include all of the operations described, fewer than the operations described, and/or more than the operations described. Likewise, it should be noted that content acquired or produced, such as, for example, input signals, output signals, operations, results, etc. associated with the examples provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the descriptions herein references particular aspects and/or features illustrated in certain other figures, one or more operations may be performed with other aspects and/or features.

Also, discussion herein may sometimes refer to various labels, which are not meant, by themselves, to define particular aspects of disclosed subject matter. Rather, these or like labels in various contexts are provided merely for convenience and/or ease of discussion and may refer to example blockchain-type assets (e.g., cryptocurrency, etc.) and/or may refer to one or more aspects of an example process, protocol, etc. for managing and/or trading blockchain-type assets. Also, for example, the discussion below may sometimes refer to a “token” and/or the like and/or may refer to an “exchange” and/or the like. “Tokenomics” and/or the like may refer to an example computing protocol, infrastructure, ecosystem and/or exchange, for example, capable of implementing one or more processing operations to facilitate and/or support coin creation, management, removal, etc. from a network.

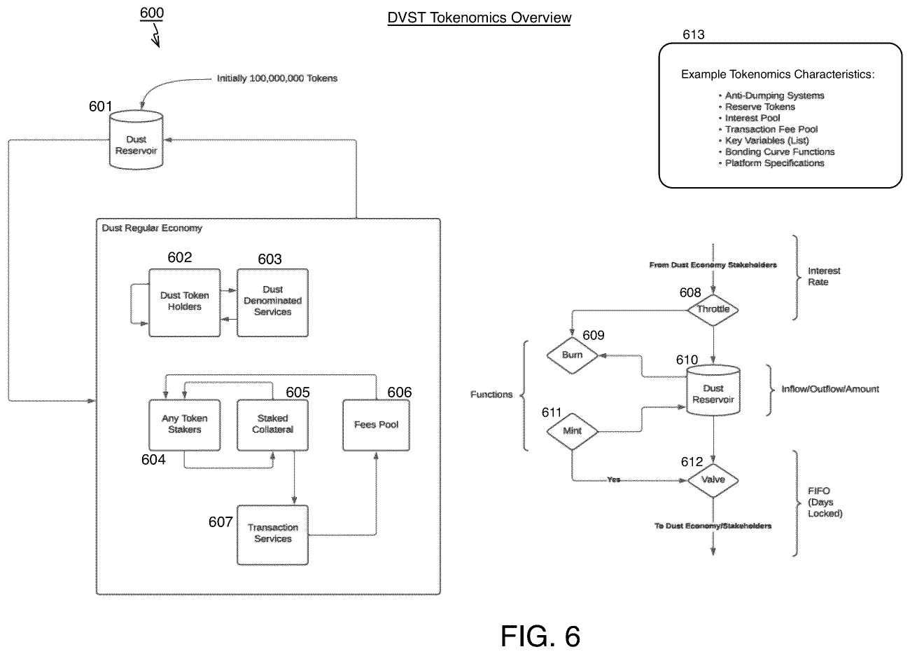

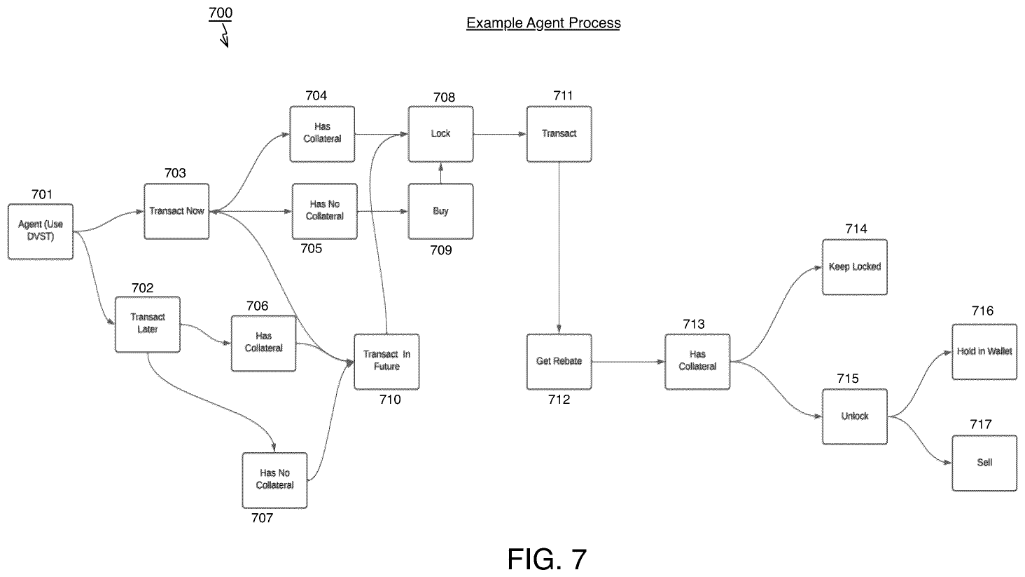

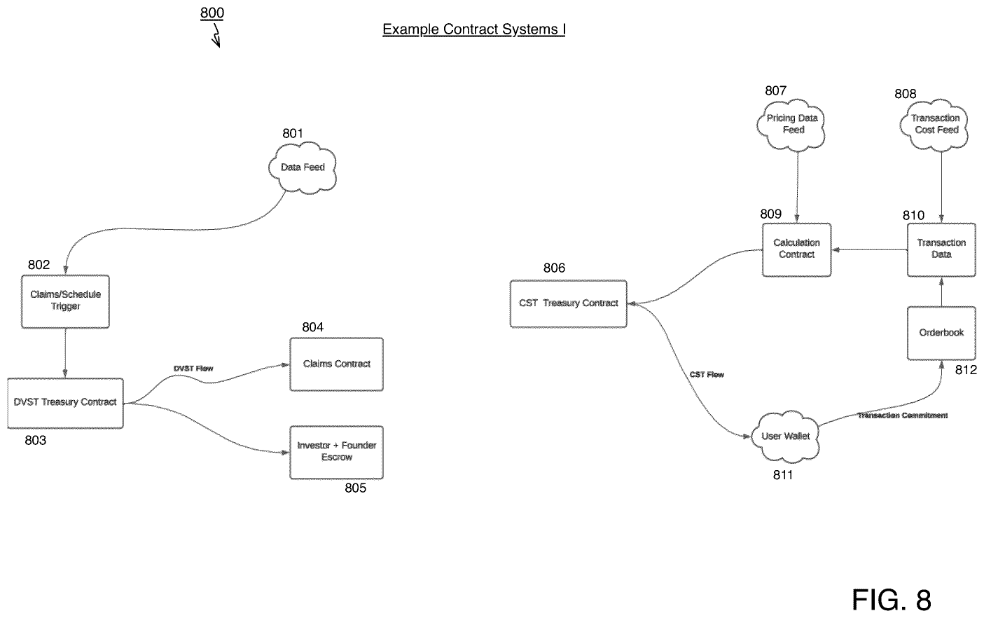

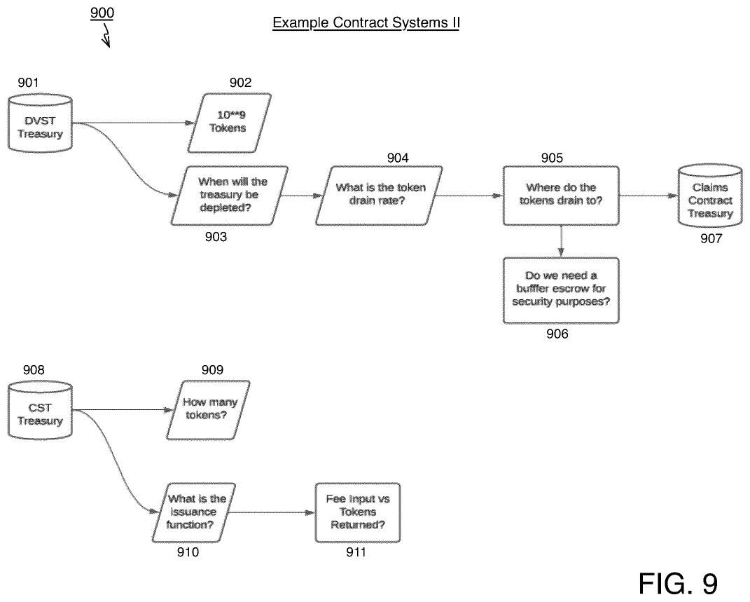

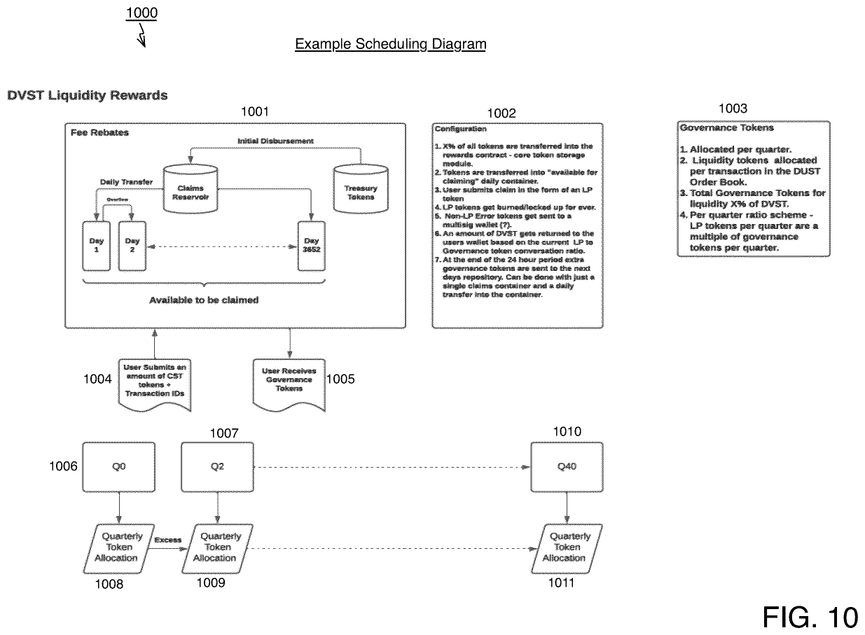

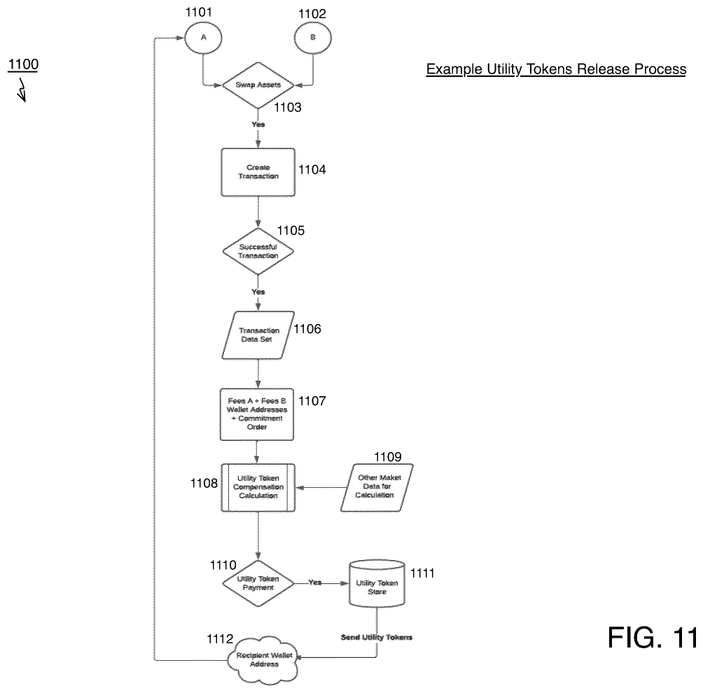

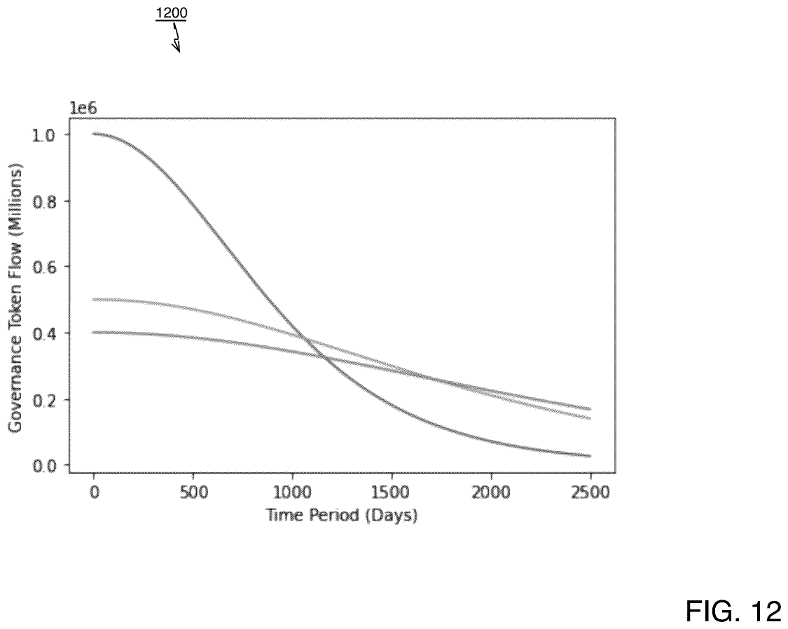

Embodiments may comprise example processes and/or operations depicted in FIGS. 6-12, including a tokenomics overview process 600, example agent process 700, example contract systems processes 800, example contract systems processes 900, example scheduling diagram and/or process 1000, example utility tokens release process 1100, and/or example governance token flow chart 1200. In implementations, example tokenomics overview process 600 may include operations depicted at self-explanatory blocks 601-613. Additionally, example agent process 700 depicted in FIG. 7 may include operations shown in self-explanatory blocks 701-717 and example contract systems processes 800 may comprise operations depicted at self-explanatory blocks 801-812, for example. Further, for example, contract systems processes 900 may include operations shown at self-explanatory blocks 901-911 and example scheduling diagram and/or process 1000 may include operations depicted at self-explanatory blocks 1001-1011. Additionally, in implementations, example utility tokens release process 1100 may comprise operations depicted at self-explanatory blocks 1101-1112. FIG. 12 depicts example governance token flow chart 1200, showing an example case of governance token flow over a period of time. Of course, subject matter is not limited in scope to the particular details of example processes 600, 700, 800, 900, 1000 and/or 1100 and is further not limited in scope to the particular details shown in chart 1200.

Additional explanation and/or additional subject matter related to example processes 600, 700, 800, 900, 1000, 1100 and/or other processes and/or implementations is provided below. Similarly, the discussion that follows may be better understood in at least some aspects by referencing FIGS. 6-12, although, again, subject matter is not limited in scope in these respects.

Contracts Overview

Calculation Contract (Internal)

In an implementation, this example contract may obtain content (e.g., data) from a content store and may utilize that content to calculate spread curves across multiple exchanges. Spread calculations may then be compared to spread pairs in an exchange, for example.

Utility Token Mint

In an implementation, this contract may mint and/or burn utility tokens. There may be, for example, up to an infinite number of utility tokens and/or these tokens may be minted on demand, in an implementation. The utility token mint contract may obtain input from a compensation contract, for example. In an implementation, the input may comprise the form [amount, wallet address]. Also, in an implementation, an output of the contract may provide the amount parameter to the wallet address obtained from the compensation contract.

Transaction Fee Contract (Internal Oracle)

In an implementation, this contract may obtain an input feed from an order book and for each unique transaction in the order book may calculate a cost fingerprint for the transaction. “Cost fingerprint” and/or the like refers to an amount paid by the Maker plus an amount paid by the Taker to third party distributed ledger service providers, for example. Alternatively, in an implementation, the transaction fee contract may obtain as an input the average current transaction costs on a given input distributed ledger (on a per minute basis, for example).

Compensation Contract

In an implementation, the compensation contract may obtain one or more inputs from the order book, from the calculation contract, and/or from the transaction fee contract. In an implementation, individual transactions in the order book may have one or more of the following compensation variables associated [spread differential, spread per unit volume, transaction cost maker, transaction cost taker]. These variables may be used to compute compensation due to the Maker. In an implementation, inventory may be needed to run the exchange and, because Makers bring inventory, emphasis may be put on the Taker side of the transaction with respect to compensation. A compensation algorithm may form part of an example tokenomics protocol, infrastructure, ecosystem and/or exchange, for example.

Governance Token Treasury

In an implementation, this contract may comprise a treasury that may contain governance tokens (e.g., 1×10⁹ tokens). In at least one implementation, treasury tokens may be allocated upon creation to a plurality (e.g., three) of different address locations. For example, a fraction of the tokens may be allocated to the raise (e.g., funding via token sales, etc.), another fraction to a foundation (e.g., for financing via returns from sales of treasury assets, in treasury holdings, etc.) and/or decentralized autonomous organization (DAO), and the remainder may be allocated to a claims contract.

Claims Contract

In an implementation, the claims contract may convert claims in the form [utility token amount, wallet address], for example, into governance tokens. In an implementation, the conversion algorithm may form part of tokenomics.

Staking Contract

In an implementation, the staking contract may offer utility tokens for governance tokens that are staked. This may allow existing token holders to gain utility from token positions that are being hodled (e.g., held) and/or participate in governance token allocation pools, for example.

Tokenomics (Practical Application of a Model Via Tailored Set or Rules)

In an implementation, the tokenomics may revolve around two main tokens, a utility token and a governance token. The governance token may be used as compensation for users who have provided utility to the platform and the utility token may be used as an accounting measure to track the cost to the user of using the exchange in particular aspects including (1) as a Maker is there an opportunity cost of using the exchange to list inventory as opposed to another exchange, (2) is there a cost to transact on a third party blockchain as part of the exchange process, (3) are there any other imputed costs to using the ecosystem as a service, for example.

Compensation Algorithm

In an implementation, the system may compensate traders for transactions that occur. Individual transactions placed on the order book may have the following associated content, for example: [Order Book ID, Maker ID, Taker ID, Maker Blockchain, Taker Blockchain, Sell Amount, Buy Amount, Timestamp]. Also, in an implementation, the transaction may have transaction cost content associated with it, such as, for example: [Maker Blockchain Transaction Cost, Taker Blockchain Transaction Cost, Timestamp] [Maker Blockchain Average Transaction Cost, Taker Blockchain Average Transaction Cost, Timestamp]. Further, in an implementation, the transaction may have spread data set associated to it based at least in part on the token pair, for example: [Token Pair, Average Market Spread, Spread Standard Deviation, Order Book Spread, Volume, Timestamp]. The spread may be defined as shown in relation (1), below:

Δ(t)=πₐ(t)−π_{b}(t) (1)

wherein πₐ(t) represents a best selling price at time t and π_{b}(t) represents the best buying price at time t, for example. In an implementation, the average market spread may comprise the spread taken over the same token pair over some set of exchanges in the market. The order book spread may comprise the spread taken over the pair for the set of orders currently in the order book, for example. In an implementation, the spread distribution may be assumed to be normal with an average and/or standard deviation calculated across the different exchanges.

Spread

In an implementation, spread may form at least in part as a result of order liquidity and/or of order impact. For example, when trading volume is small adding more liquidity may help improve price accuracy and/or may reduce spread, but after some point additional liquidity may begin to deteriorate price. In an implementation, the model may connect the bid-ask spread and high-low bars to measurable microstructural parameters and/or may express their dependence on trading volume, volatility and/or time horizon, for example. Using the established relations, one may address the operating spread optimization challenge to improve and/or maximize the Maker's profit.

In an implementation, an equation for the behavior of spread may be given as shown in relation (2):

$$Δ = {λ}_{S} \sqrt{\frac{n {σ}^{2}}{V}} \qquad ( 2 )$$

wherein λ represents a constant fitting parameter, σ² represents volatility of the asset, n represents the average transaction size and/or V represents the volume. In an implementation, it may be assumed that price follows a Gaussian random walk with volatility σ. Relation (2) may comprise a rule-of-thumb for spread behavior, for example. For the discussion below, a Quantum Coupled Wave Model may be utilized to describe the behavior of spread in more general terms. In an implementation, a Python script may run a spread calculation and/or may look at spread vs volume, as well as spread vs time, from an input set of real-world data.

Using the K-S Distance

The Kolmogorov-Smirnov statistic may provide the distance between two distributions (e.g., an empirical one and a theoretical one). For example, let Fₙ(x) be an empirical (sample) distribution and let F(x) be a theoretical distribution. In an implementation, the K-S statistic may be provided in accordance with relation (3):

Dₙ=ₓ^{sup}|Fₙ(x)−F(x)| (3)

In an implementation, the K-S distance may be utilized to compare distributions. For example, if x represents volume and we have two distributions for spread vs. volume, then the K-S distance may be utilized for comparison purposes.

The Global Liquidity Index (GLIX)

In an implementation, GLIX may look at the top “x” coins from CoinMarketCap/Coin Gecko excluding BTC and Stablecoins, for example, and/or may calculate the average spread of those top “x” coins on a particular exchange in comparison to some base currency. In an implementation, the K-S distance may be calculated to see how far away the spread is in a given pair of coins from the GLIX.

Compensation Methods (Utility Tokens)

Using the values calculated previously, agents (e.g., users) may be compensated for using the exchange, in an implementation.

Method 1

In an implementation, a primary compensation method may include transaction fee rebates. Given a particular transaction, part of the cost of transacting may comprise the price paid to third parties, for example. This may comprise a sum of the Maker fee plus the Taker fee, in an implementation. Let X be a unique label assigned to the particular transaction in the order book, and let the fees paid to third party service providers be represented as Mₓ on the Maker side and Tₓ on the Taker side. In an implementation, the total fees may be calculated in accordance with relation (4) below.

Cₓ=Mₓ+Tₓ (4)

In an implementation, it may be a goal to rebate a percentage of the total fees Cₓ to the Maker. Let Cₓ 0≤λ≤1−ϕ wherein

$$ϕ ∈ [ \frac{1}{100} , \frac{1}{2} ] .$$

In an implementation, the parameter ϕ may comprise a regulatory parameter that may be set by the DAO. In an implementation, let μ∈[0,1]. In an implementation, compensation may be set in accordance with relation (5):

Rₓ=μ·Cₓ=Mₓ+λTₓ (5)

wherein Rₓ represents a total rebate amount in the units of utility tokens, for example. It may be noted that less than 100% of the costs are reimbursed, for example. The values of λ, ϕ may be set on a pair-by-pair basis, in an implementation. For example, Makers may be compensated (e.g., fully) and the method may have a constraint Rₓ≥Mₓ. In an implementation, the parameter μ may act as a switch to turn the compensation mechanism off or on. In an implementation, μ may be set to a value between zero and one to allow for adjustment of the overall rebate percentage. Also, in an implementation, the spread distribution may be utilized to fine tune the value of λ.

Method 2

In an implementation, a second compensation method may include giving market makers (e.g., liquidity providers), who may frequently and/or continuously exchange buy and/or sell positions in a pair and/or provide volume and/or fast liquidity for Takers, a form of compensation based at least in part on spread vs. volume, spread vs. time and/or spread differentials.

In an implementation, for a fixed amount of volume, pips may be offered to the liquidity providers. Also, in an implementation, offering may be over and/or above basic transaction fee rebates. For example, the number of pips may depend at least in part on the spread calculation per unit of volume in the order book.

For example, if a liquidity provider offers 200ETH in an ETH/BTC pair and/or the spread in the order book for that amount of volume for that pair is 60 pips, then the infrastructure may offer 60 pips worth of compensation in utility tokens.

A challenge for the market Maker may include rebasing. For example, if the amount in utility tokens is rebased when it is converted into governance tokens, market Makers may not know exactly what their compensation will be. It may prove challenging with this type of compensation to get market Makers to trust the reward signal(s) for making the market, for example. Also, for example, market Makers may also desire to convert from utility tokens to governance tokens and then back to their original currency with a clear indication of the value of the interchange.

It may be advantageous to design a scheme based at least in part on the probability of a rebasing event occurring. For example, let p(x) be the probability of an x percent rebasing of the governance tokens available during any particular claims period. As the probability of rebasing increases, the number of pips available to market Makers and/or liquidity providers (e.g., when pips are measured in utility tokens) may be increased, in an implementation.

Governance Token Conversion

In a discrete time setting, implementations may include some sequence that may correspond to a utility delta in individual time periods. Implementations may also include a governance token delta that may correspond to issued governance tokens against claims. Consider relation (6):

S₁→S₂→S₃→ . . . →Sₙ (6)

In an implementations, the total utility tokens issued would be the sum ΣᵢSᵢ and this may be claimable against some number of governance tokens. For example, the let relation (7) represent governance token allocation for the issued utility tokens:

G₁→G₂→ . . . →Gₙ (7)

In an implementation, an allocation algorithm may map governance tokens to claimed utility tokens. Responsive at least in part to an agent sending a utility token to the contract, a governance token may be returned against that utility token.

Claims Contract

Inputs, for an implementation: Claims by users to be converted into governance tokens, price feed for the price of governance tokens.

Contract Variables
i represents the allocation period
Cᵢ represents the claim amount of utility tokens in the period
Sᵢ* represents outstanding claims from previous rounds
Sᵢ represents the issuance amount of utility tokens in the period
Gᵢ represents the allocation amount of governance tokens
Sᵢ+Cᵢ represents claims differential during the period
rᵢ=Cᵢ/Sᵢ represents the ratio of claims to issuance in the period
φᵢ represents the cost for running a claim (measured in base currency)
Nᵢ represents the number of unique claims
\hat{P}ᵢ represents the average price of governance tokens during the claims window
P₀ represents price floor/initial price
qᵢ represents the collateral requirement (in governance tokens) during the period
dᵢ represents the collateral requirement (in other tokens) during the period
dᵢ−qᵢ represents the collateral differential
λ represents the fraction of governance tokens for presale/foundation etc.
(1−λ) represents the fraction of governance tokens allocated for use in the claims contract
Ω represents the initial mint amount (total governance tokens minted)
Ωᵢ represents the total amount of governance tokens left in the treasury/for compensation at the start of period and before has been deducted. We use this to work out.
i=T represents Last Period
i=1 represents Initial Period
i=0 represents Preload/Prelaunch Period
j represents claimant
πᵢ represents Proportion of total claims due to claimant
Cᵢⱼ represents claim value in utility tokens of claim
Gᵢⱼ represents payout in governance tokens for claim
η represents rebasing counter
b represents base transfer for claims servicing

Modelling Variables
πᵢ represents average number of utility tokens issued in the period per transaction
Φᵢ represents number of transactions (count staking claims, etc., as transactions+exchange behavior)
vᵢ represents average transaction value (e.g., in base currency) against which rebates are issued
Sᵢ=∈ᵢΦᵢ represents issuance amount

Output: Payouts in governance tokens to a list of claimants.

Running the Claims Contract

The example protocol and/or process described below is merely an example, and subject matter is not limited in scope in these respects. Embodiments may include all of the operations described, fewer than the operations described, and/or more than the operations described. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

Operation 0:
Calculate the value of Gᵢ.

Operation 1:
Allocate Gᵢ tokens to the claims contract for claims
The amount Gᵢ is deducted from Ωᵢ and Ωᵢ→Ωᵢ₊₁=Ωᵢ−Gᵢ

Operation 2:
Collect the list of submitted claims, aggregate the total claims value Cᵢ by summing the individual claims in the list individual claims are Cᵢⱼ=πᵢCᵢ

Operation 3:
Implement whatever price conditions (e.g., on the governance token) that could halt the allocation or shift it to the next period in time.
Compare the value of Cᵢ and Gᵢ in base currency (e.g., to rebase or not to rebase?)

Operation 4:
Make the payouts to users:
   Cᵢ≥\hat{P}ᵢ×Gᵢ (Rebase all amounts and pay Gᵢⱼ=πᵢGᵢ for claim Cᵢⱼ)
   Update the rebasing counter if rebasing occurs, η→η+1
   Cᵢ<\hat{P}ᵢGᵢ (Pay the base currency face value of the claim)

Calculating Gᵢ Allocation

In an implementation, responsive at least in part to completion of individual claims periods, the following may be considered:
1. Did a rebasing event happen?
2. Is the price lower than it was in the previous period?
3. If the price was lower than it was in the previous period, then by how much was it lower?
4. What is the volatility of the governance token?
5. How many claims tokens were generated and claimed? What is the claims ratio? What is the claims differential?
6. What are the collateral requirements?

In an implementation, an infrastructure may act as collateral for the rest of the economy. For example, it may work a bit like the ETH/DAI relationship created by MakerDAO, although subject matter is not limited in scope in this respect. In an implementation, instead of users creating stable coins based on collateral, pseudo-stable coins may be created based at least in part on the value of the governance token (e.g., collateral vault). For example, the amount of collateral that users can claim back may be selected based at least in part on activity.
(A) If rebasing occurred, increase b→μb, so that more tokens may be available in a subsequent (e.g., next) claim cycle to cover system debts. In an implementation, the base collateral value may remain unchanged until rebasing happens, for example.
(B) If rebasing did not occur, then this may indicate that the price went up and/or there were not enough claims made. In such a circumstance, there may also be a leftover balance Gᵢ−Cᵢ/\hat{P}ᵢ.

In an implementation, in the event that no rebasing occurred, then an operation to transfer (or hold) a percentage (e.g., 98%) of the leftover amount for a subsequent (e.g., next) batch of claims and/or to burn a percentage (e.g., 2%) of the excess governance tokens. A particular aspect to note in this regard is that an over-allocation of governance tokens may lead to burning. In an implementation, price conditions may be implemented to defend the floor price in the economy, for example. It may be noted that may comprise an initial price floor, and it may be advantageous to introduce some conditions on future price floor(s) through some sequence and/or via voting, in an implementation. In an implementation, generally, if the average market price is below the price floor, and there has been a shorting attack on the ecosystem, then, to defend the ecosystem, for example, the rewards mechanism may be closed and/or the available governance tokens may be pushed into the future to allow for payment of claims at a later stage once the price recovers. This policy may be relatively important in the early stages of the ecosystem but may become less important in circumstances in which the maximum governance token allocation during a particular day does not have significant price impact. In another implementation, instead of an “all or nothing” approach, some sort of overflow control (e.g., 25%/50%/75%100%) may be implemented, for example.

Base Rate Adjustment Algorithm

Techniques for Setting Gᵢ

In order to avoid confusion with previous notation, let Ω₀ represent an initial amount of governance tokens committed to a claims contract, and let ω₀ represent a scaling factor (e.g., measured in utility tokens).

In an implementation, G=F(Ω₀,ω₀,S,t) may be set as a mapping of cumulative utility into cumulative governance tokens at time t. Further, let s=\dot{S} and g=Ġ represent a rate of flow of utility tokens and governance tokens over time, respectively, for example.

In an implementation, the above may yield

$$\frac{g}{s} = \frac{dF}{dS}$$

which may set a price in governance tokens for utility tokens. This may act as a bonding curve for the ecosystem, for example. In an implementation, a number of utility tokens or a number of governance tokens may be allocated (e.g., in a discrete set per period).

For example, utilizing a curve G=Ω₀ tanh

$$( \frac{s}{{ω}_{0}} )$$

may set up a bonding curve:

$$\frac{dG}{dS} = ( {Ω}_{0} / {ω}_{0} ) {sech}^{2} ( S / {ω}_{0} ) .$$

In an implementation, this may map a finite amount of governance tokens to up to an infinite amount of utility tokens, for example, and/or may set a specific price for conversion using the bonding curve.

However, it may be advantageous to understand and/or set either g or s for system operation, in an implementation. For example, utilizing a constant sᵢ=a×10⁷ and/or allocating equal amounts of utility token to individual time periods may imply that the allocation of governance tokens may follow a curve such as depicted in FIG. 12. For example, FIG. 12 depicts an outflow (blue) sᵢ=10⁷; (orange) sᵢ=0.5×10⁷ and (green) sᵢ=0.25×10⁷ utility tokens using the bonding curve mentioned above with Ω₀=10⁹ and ω₀=10¹⁰. Of course, as mentioned, subject matter is not limited in scope to the particular examples described herein.

In an implementation, an alternate process may include setting the flow of governance tokens and/or to allow the amount of utility tokens issued to vary with rebasing where advantageous and/or necessary.

For example, let b represent a base amount of governance tokens. Also, for example, in a particular circumstance b may be either too high or too low in round land it may be advantageous to adjust b in round i+1 depending at least in part on whether or not rebasing has occurred.

In an implementation, an example self-adjusting technique may include the following.
i represents a current round
i+1 represents next round
bᵢ represents a current allocation of governance tokens
bᵢ₊₁ represents a subsequent (next) allocation/transfer of governance tokens
qᵢ∈{0,1} represents rebasing boolean for round i
\hat{P}ᵢ represents average price over some relevant window
F₀ represents an initial market floor (e.g., adjusts over time based on expected price curve)
E(\hat{P}ᵢ)=(1+a)^{k}F₀ represents an expected price curve (e.g., compounds every 30 days from the market floor)
Fᵢ represents a current floor price
a represents a growth factor
k represents intervals (e.g., 30 day)
Λᵢ represents residual tokens from cycle i
r represents a token burn rate
Qᵢ represents a suggested market price at the end of cycle i
bₘᵢₙ represents a base rate floor
bₘₐₓ represents a base rate ceiling
Vᵢ=\hat{P}ᵢbᵢ represents a value allocation
μₗ represents a reduction factor
μᵤ represents an increment factor

In an implementation, a base rate may be set for an initial period, and a value allocated may be at least V₀=P₀b₀. Subsequently, claims may be collected and/or a test may be performed to determine whether C₀≤V₀ or C₀>V₀ (rebasing). More generally, Cᵢ≤Vᵢ or Cᵢ>Vᵢ.

In an implementation, for a circumstance in which no rebasing happens, qᵢ=0 and:

bᵢ₊₁=(1−μₗ)bᵢ−(1−r)Λᵢ
Fᵢ (defend new floor)
Qᵢ=\hat{P}ᵢ (suggested price is the secondary price average)
rΛⱼ(automatic burn policy)

Further, in an implementation, the base number of available tokens may be reduced and tokens from the previous round may be allocated (e.g., so there may be no need to transfer an additional (1−r)Λᵢ).

In an implementation, for a circumstance in which rebasing happens qᵢ=0 and:

bᵢ₊₁=(1−μᵤ)bᵢ
E(\hat{P}ᵢ)=(1+a)^{k}F₀ (rebase the debt using at most the expected price)
Qᵢ₊₁=E(\hat{P}ᵢ) (replace secondary price with expected price)
Fᵢ(defend new floor)

In an implementation, upper and/or lower bounds bₘᵢₙ≤bᵢ≤bₘᵢₙ may be maintained. For a circumstance in which the price floor does not hold and \hat{P}ᵢ<Fᵢ, the claims contract may be switched off, for example. Also, for example, in the event of stagnation (e.g., \hat{P}ᵢ≈Fᵢ) the base governance token allocation may be reduced by some factor.

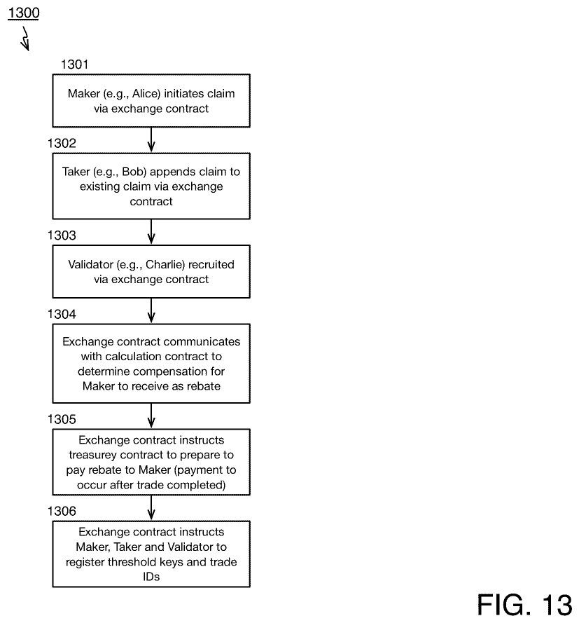

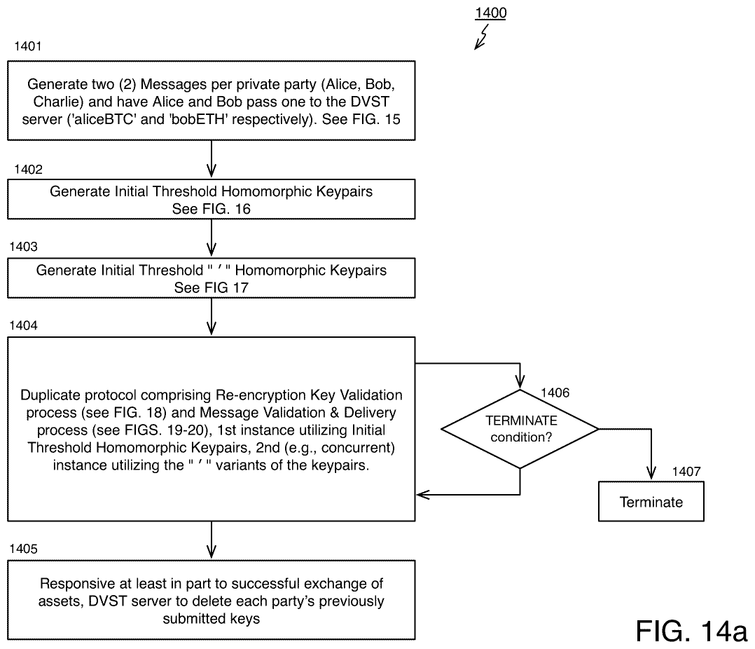

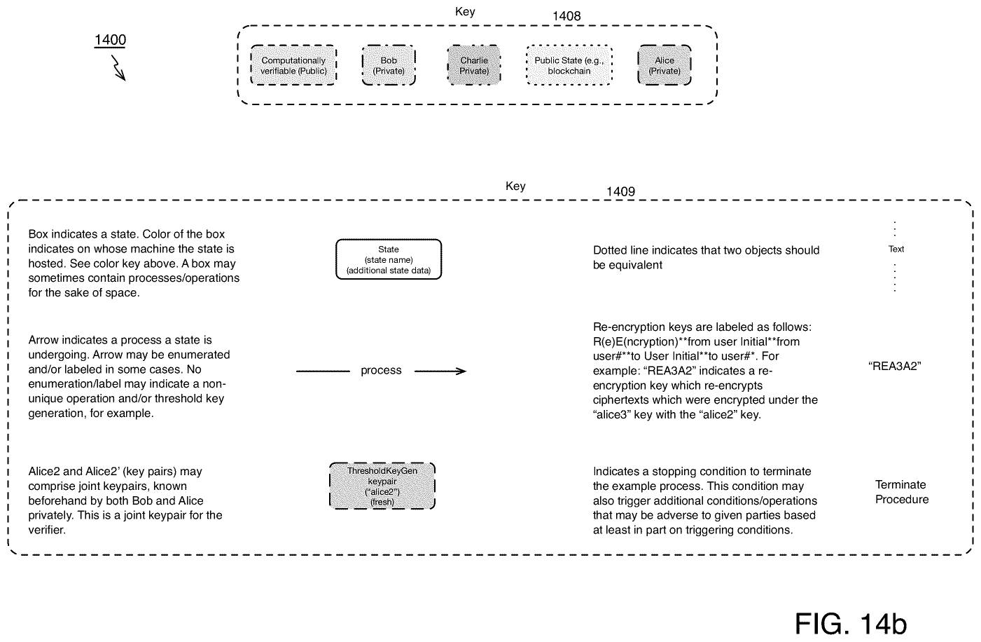

FIG. 13 depicts a flow diagram of an example process 1300 for initiating an on-line transaction (e.g., cryptocurrency buying, selling, etc.) in accordance with particular embodiments. In an implementation, example process 1300 may initiate one or more aspects of the example process depicted in FIG. 14A. For example, example operations depicted in FIG. 14A may provide for exchanges of assets, keys, etc. in support of and/or to implement, at least in part, example process 1300. Embodiments may include all of the operations described, fewer than the operations described, and/or more than the operations described in example process 1300. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

In an implementation, as shown at block 1301, a particular computing process receiving input from a user “Alice” (e.g., Maker) may initiate a claim via an exchange contract. For example, an exchange contract may comprise one or more aspects similar to exchange contracts discussed previously. As also depicted in FIG. 13, example process 1300 may include another computing operation, as depicted at block 1302, wherein “Bob” (e.g., Taker) appends a claim to the existing claim previously initiated by Alice. Again, appending the claim may be performed via an exchange contract, for example. Additionally, in an implementation, a third-party computing process “Charlie” may be recruited as a Validator, as indicated at block 1303.

In an implementation, example process 1300 may further include an exchange contract communicating with a calculation contract, for example, to determine compensation for Bob (e.g., Maker) to receive as a rebate, as depicted at block 1304. Also, for example, an exchange contract may instruct a treasury contract to prepare to pay a rebate to Bob (e.g., Maker), as depicted at block 1305. In an implementation, payment of rebate may occur at a later point in time.

Further, for example process 1300, an exchange contract may instruct Alice (Maker), Bob (Taker) and Charlie (Validator) to register threshold keys and/or to register identifiers (IDs), as indicated at block 1306.

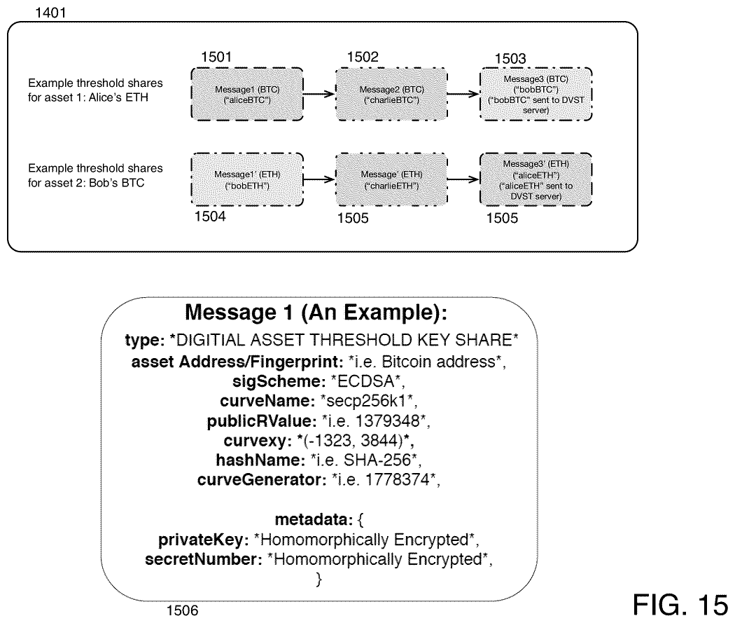

FIG. 14A is a flow diagram illustrating an embodiment 1400 of an example process for exchanging cryptographic assets between parties. In implementations, example process 1400 may provide for exchanges of assets, keys, etc. in support of and/or to implement, at least in part, example process 1300. In implementations, the example process 1400, including, for example, operations of FIGS. 15-20, may be referred to as a “protocol” although subject matter is not limited in scope in these respects.

As mentioned, two parties, such as Alice and Bob, for example, may wish to exchange digital assets that they respectively own. For example, Alice may hold some ETH assets at a particular address (e.g., location on a blockchain) and Bob may hold some BTC assets at another address. One technique for exchanging such assets may be to simply perform an atomic swap via a DEX. As discussed previously, this manner of exchanging assets may pose a number of challenges, problems, etc., including significant economic concerns.

Another technique for exchanging digital assets, such as the ETH assets held by Alice and the BTC assets held by Bob in this current example, may include utilization of example processes described herein, such as discussed above in connection with FIG. 13 and as further discussed below with additional detail. As mentioned, in implementations, an exchange of assets between Alice and Bob, for example, may include communication of messages (e.g., shares of newly generated addresses) of, in this example, financial value in two directions (e.g., across different assets) with the help of a third party, such as Charlie, acting as a validator to help verify communication of messages. Again, example implementations may include at least some aspects of example process 1300 discussed above. Implementations may significantly reduce and/or eliminate economic, speed and/or security concerns, for example.

Embodiments described herein in connection with FIGS. 14a-20, for example, may include all of the operations described and/or depicted, fewer than the operations described and/or depicted, and/or more than the operations described and/or depicted in FIGS. 14a-20. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

As depicted in FIG. 14a, process 1400 (e.g., a protocol) may include generation of two messages per party (e.g., Alice, Bob, Charlie), for example, as depicted at block 1401. Also, Alice and Bob, for example, may pass messages (e.g., “aliceBTC” and “bobETH” respectively) to a server computing device (e.g., a server). See FIG. 15, discussed more fully below, for example.

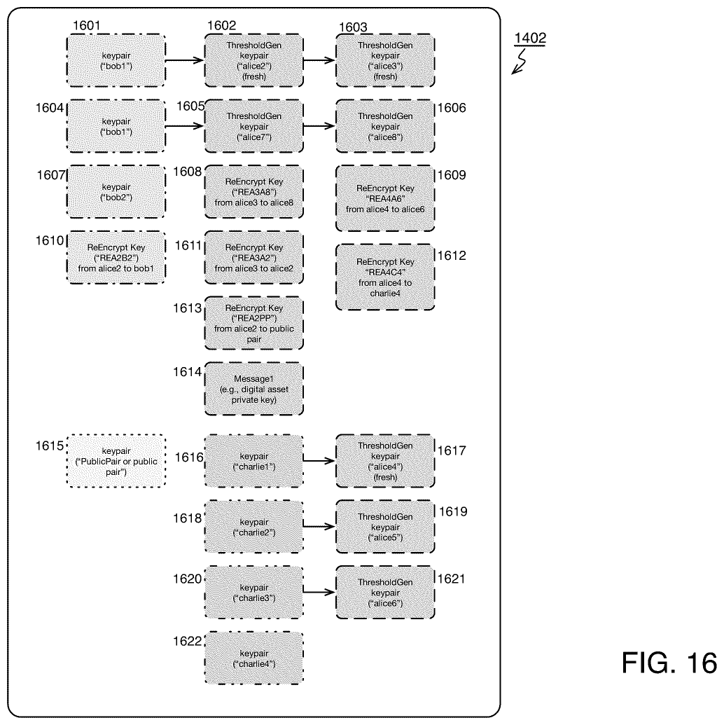

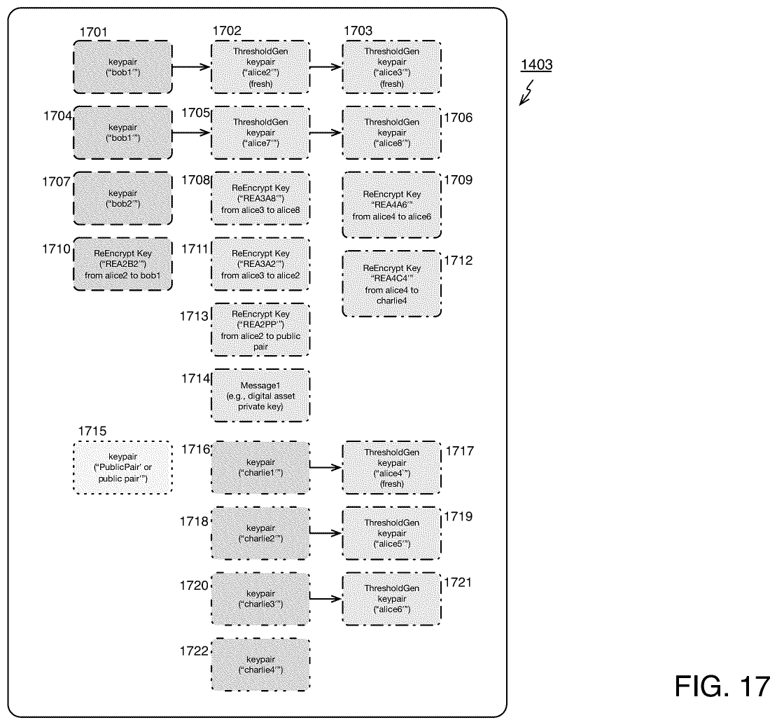

As further indicated at block 1402, in implementations, example process 1400 (e.g., a protocol) may include generation of Initial Threshold Homomorphic Keypairs. See FIG. 16, for example, discussed more fully below. As also indicated at block 1403, example process 1400 (e.g., a protocol) may include generation of an alternative “prime” (“′”) set of keypairs that may be referred to Initial Threshold “′” Homomorphic Keypairs. See FIG. 17, for example.

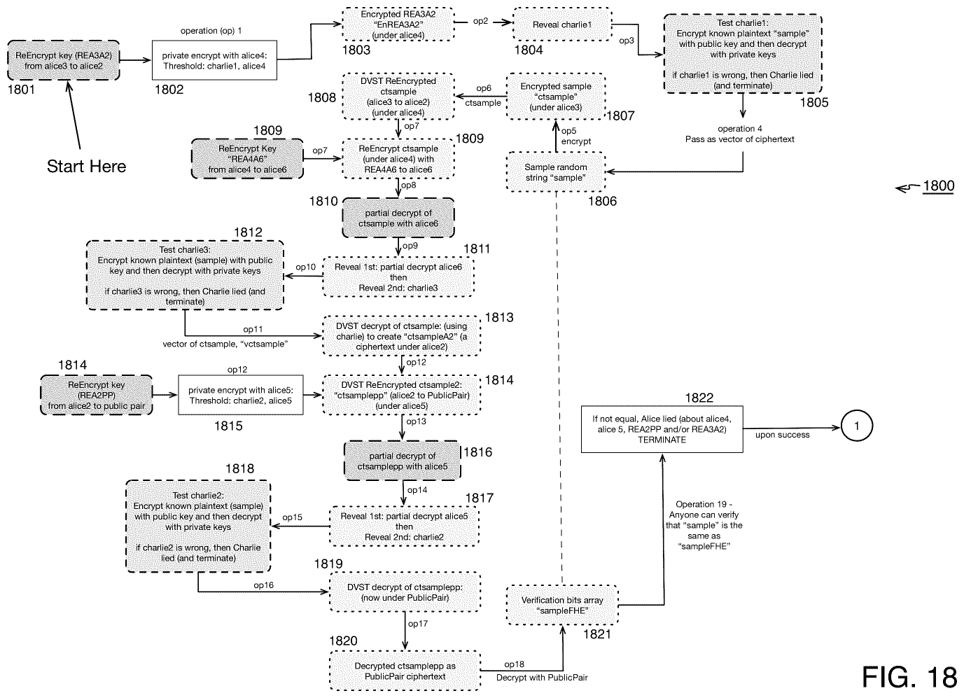

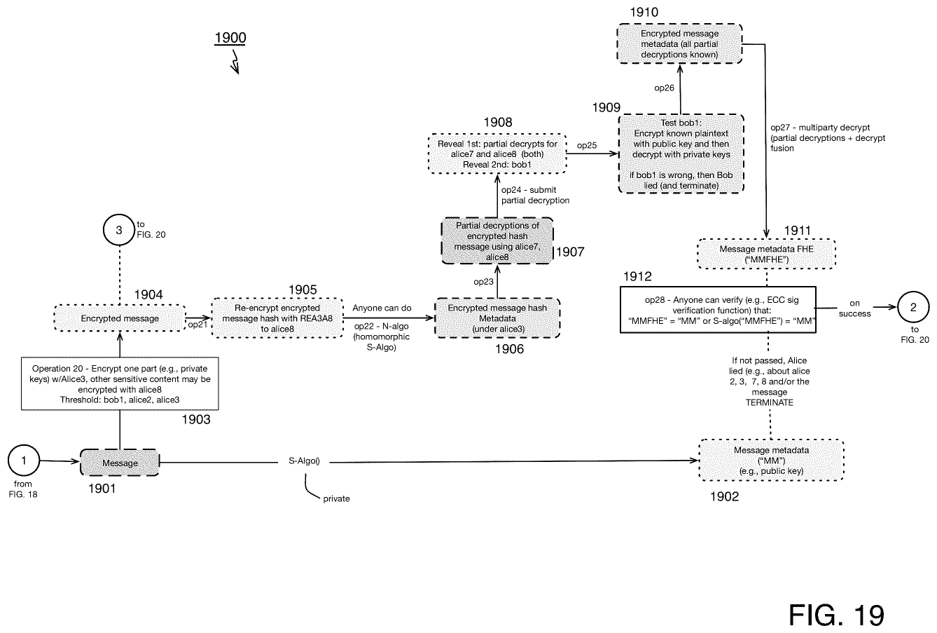

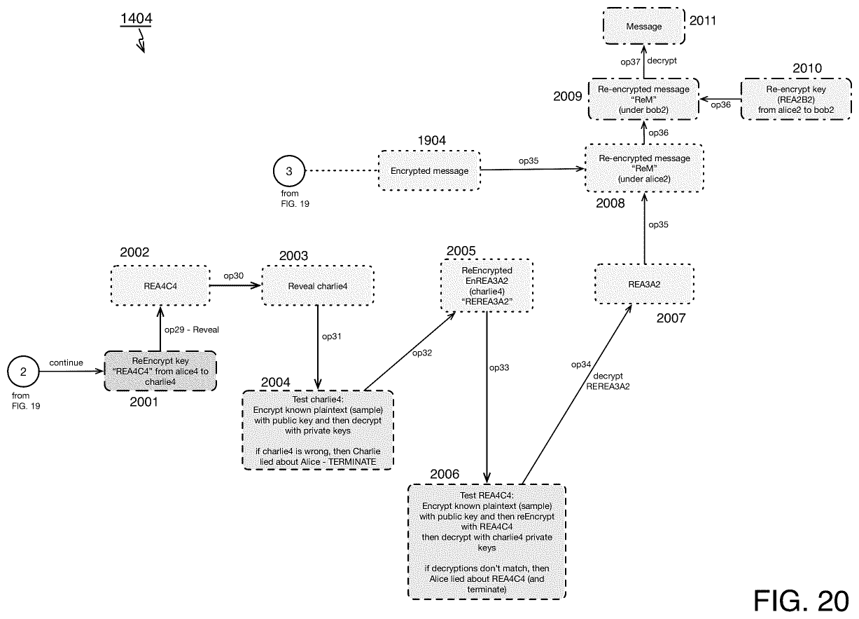

Additionally, in implementations, as indicated at block 1404, a protocol (e.g., process 1400) may include performing duplicate iterations of a protocol including a Re-encryption Key Validation process (e.g., process 1800, see FIG. 18) and a Message Validation and Delivery process (e.g., process 1900, see FIGS. 19-20). As indicated at block 1405, process 1400 may also include, responsive at least in part to successful exchange of assets, deletion by the server of each party's previously submitted keys, for example. Blocks 1406 and/or 1407 depict an operation to determine whether example process 1400 should terminate, for example.

The various example operations of example process 1400 (e.g., a protocol) are discussed in more detail below.

FIG. 14b provides a key, depicted at blocks 1408 and 1409, for process 1400, including for example operations depicted in FIGS. 15-20. For example, the key depicted at blocks 1408 and 1409 may denote particular operations that may be performed on a computing device associated with and/or co-located with Alice and/or may denote assets, keys, etc. that may be stored on a computing device associated with and/or co-located with Alice. That is, particular operations, keys, assets, etc. may be “private” to Alice (e.g., only Alice may view such operations). Similarly, the key denotes particular operations, keys, assets, etc. that may be private to Bob (e.g., performed and/or stored on a computing device associated with and/or co-located with Bob) and further denotes particular operations, keys, assets, etc. that may be private to Charlie (e.g., performed and/or stored on a computing device associated with and/or co-located with Charlie). The key also denotes operations, keys, assets, etc. that may be “public” (e.g., viewable by anyone, including those other than Alice, Bob and/or Charlie, such as on a blockchain). Other operations, keys, assets, etc. may be publicly computationally verifiable, as depicted. FIG. 14b further provides an additional key to aid understanding of example keys, states, operations, processes, procedures, etc. depicted in FIGS. 15-20.

A glossary is provided below to aid understanding of example processes, operations and/or procedures described herein, including example processes, operations and/or procedures discussed and/or depicted in connection with process 1400 (e.g., in connection with FIGS. 15-20).

Homomorphic encryption: Homomorphic encryption schemes may be characterized, at least in part, by a capability to evaluate addition, multiplication and/or vector rotation on encrypted values, for example. Homomorphic encryption may further be characterized, at least in part, by usage of homomorphic primitives based on the hardness of the Learning With Errors (LWE) problem (which may itself be based on the hardness of the GapSVP and/or SIVP problems), for example, to encrypt a plaintext. Homomorphic decryption may be characterized, at least in part, by usage of homomorphic primitives based on the hardness of the LWE problem and the private component of a keypair, for example, to convert a ciphertext into plaintext. Example homomorphic encryption schemes may include, but are not limited to, Cheon-Kim-Kim-Song (CKKS) encryption and/or BGVrns encryption. In implementations, a leveled somewhat homomorphic encryption technique may be utilized wherein there may be fixed number of consecutive operations (e.g., mostly bounded by multiplication) that may be performed on ciphertexts.

Vector A vector may comprise a one-dimensional array that may contain strings, numbers, etc. (e.g., [a, b, c, d, e, f, g]).

Proxy re-encryption (PRE): PRE schemes may comprise cryptosystems that may allow third parties (e.g., proxies) to alter a ciphertext which has been encrypted for one party so that it may be decrypted by another, for example.

Cleartext: Cleartext may comprise a human-readable string of characters in any acceptable format and/or subformat (e.g., Unicode subformat), for example.

Plaintext: Plaintext may comprise an encoding of a cleartext string of characters with mathematical primitives so as to convert the characters into encryptable, usually compressed, numerical representations, for example.

Keypairs: Keypairs may comprise public and private corresponding keys. That is, a private key of a keypair may decrypt anything a corresponding public key of the keypair encrypts, for example.

Joint keypair: Joint keypair may be characterized, at least in part, by a shared secret, such as a data element, known only to the parties involved in a secure communication, for example. A shared secret may include, for example, a key, password, passphrase, number, array of randomly-chosen values, etc. The shared secret may be shared beforehand between the communicating parties (e.g., referred to as a pre-shared key) or the shared secret may be created at the start of the communication session (e.g., by using a public-key cryptography, such as Diffie-Hellman, and/or by using symmetric-key cryptography such as Kerberos), for example.

Threshold keys: In implementations, threshold keys may comprise public, private and evaluation keys for use in secure multiparty computation and/or communication. Threshold keys may be jointly negotiated by all parties involved, for example. In implementations, public and evaluation keys may be shared with everybody. Also, for example, public keys may be utilized to encrypt and the evaluation keys may be utilized to perform arithmetic comprising addition, encrypted multiplication and/or encrypted vector rotation, for example. In implementations, private keys may be utilized to jointly decrypt. For example, each party may privately compute a partial decryption and then the partial decryptions may be publicly joined to form a decrypted plaintext.

ThresholdGen( ): In implementations, ThresholdGen( ) may comprise an operation to generate threshold keys. In an implementation, threshold keys generated via a ThresholdGen( ) operation may not be re-encrypted.

Fresh: Indicates generation of threshold keys which may be utilized to produce ciphertexts and that can be re-encrypted but not with other “fresh” keys, for example.

Under: In implementations, “under” and/or “encrypted under” and/or the like indicates for a particular keypair that the plaintext corresponding to a particular ciphertext was encrypted using the particular keypair to produce the particular ciphertext, for example.

Re-Encrypt Key: In implementations, a generated re-encryption key may be utilized to re-encrypt a ciphertext encrypted under a specific keypair to another keypair.

Partial decryption: Partial decryption may comprise a fraction (e.g., pro rata share) of a decrypted threshold ciphertext (e.g., encrypted from threshold keys) with a single threshold keypair.

MultipartyDecryptFusion( ): In an implementations, a MultipartyDecryptFusion( ) operation may comprise combining any partial decryptions of a threshold ciphertext. May be considered to be equivalent in at least some respects to a decrypt operation, but for threshold keys, for example.

Encrypt( ): In implementations, a Encrypt( ) operation may comprise encryption of a ciphertext at least in part by mapping the encrypted elements of a ciphertext object to a plaintext object (e.g., “treat those objects as plaintext strings”). This may effectively create two layers of encryption (e.g., an inner layer and an outer layer). This may be similar in at least some respects to double encryption, for example.

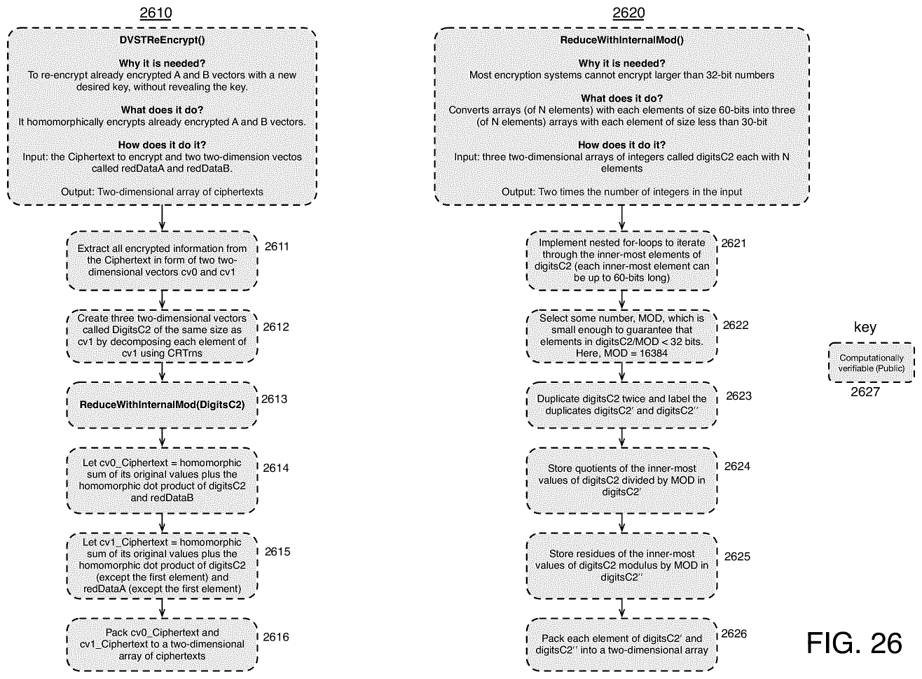

ReEncrypt( ): In implementations, a ReEncrypt( ) operation may include the usage of an encrypted ReEncrypt Key to Re-encrypt the inner layer of an encrypted ciphertext. See example process 2610 of FIG. 26, for example.

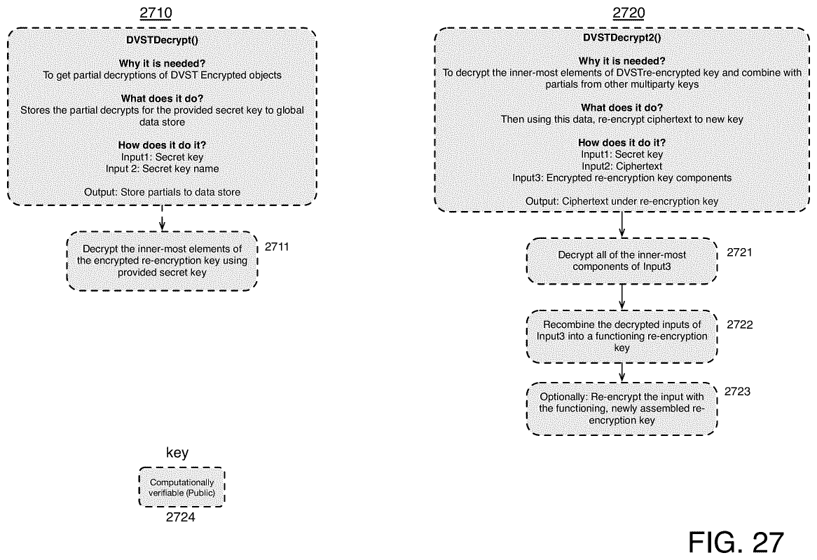

Decrypt( ): In implementations, a Decrypt( ) operation may include decryption of an outer layer of an encrypted object, for example. See, for example, process 2710 of FIG. 27.

S(outhern) Algorithm: In implementations, a S(outhern) algorithm (or S-algo) may match a private component of a message (e.g., a private key) to a public identifier (e.g., a public key) for the Message in cleartext. In implementations, an S-algorithm may include, for example: generating digital asset addresses (e.g., Bitcoin address), public keys, signatures, fingerprints, and/or pre-image hashes; and running verification algorithms on the produced signatures, public keys, fingerprints, and/or pre-image hashes. An example S-algorithm may include generating an asset public key (e.g., BTC) from a private key, generating an asset (e.g., BTC) signature, and/or performing a verification operation utilizing, at least in part, an elliptical curve digital signature algorithm, in implementations. The above operations may correctly identify a public key as belonging to a private key using private signature generation algorithms, a public signature from the private key, and finally a public verification algorithm. Of course, subject matter is not limited in scope in these respects.

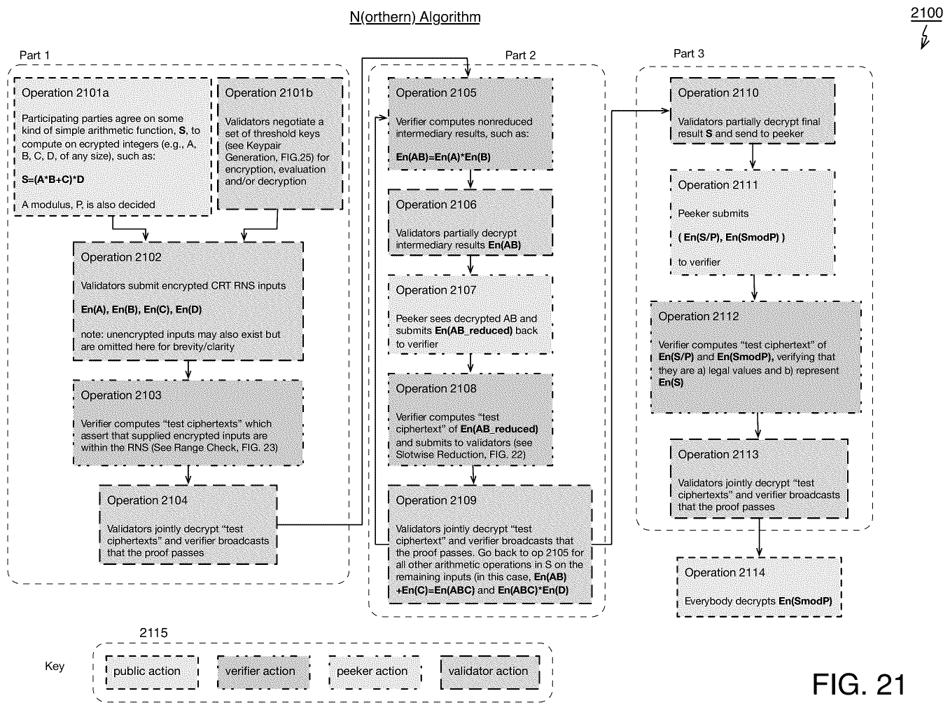

N(orthern) Algorithm: N(orthern) Algorithm (or N-algo) may refer to a homomorphic variant and/or equivalent of a Southern Algorithm. See example process 2100 of FIG. 21, for example. Note that “N(othern) Algorithm” and “Northern Algorithm” (or like terms) may be used interchangeably herein.

Truant(s): Truant(s) and/or the like may refer to a party to have failed to provide information requested by the protocol in a “timely manner,” for example.

Timely Manner Timely manner and/or the like may refer to a specified amount of on-chain (or off-chain) time by which a response must be given to a protocol inquiry, for example.

Liar(s): Liar(s) may refer to those parties (e.g., Alice, Bob and/or Charlie) who may intentionally and/or unintentionally provide misinformation (e.g., content, such as keys, that are falsifiable and have been falsified).

Punishment Function: a punishment function may, for example, implement “punishment” deterministically according to roles assigned by the protocol.

As mentioned, and as depicted at block 1401 of process 1400, in implementations, an exchange of assets between Alice and Bob, for example, may include communication of messages (e.g., shares of newly generated addresses) of, in this example, financial value in two directions (e.g., across different assets) with the help of a third party, such as Charlie, acting as a validator to help verify communication of messages. In an implementation, to initiate an exchange of assets, such as between Alice and Bob, for example, messages (e.g., two messages) per party may be generated. In an implementation, Alice and Bob may individually pass one message to a server computing device (e.g., a server performing, at least in part, a protocol in accordance with embodiments and/or implementations described herein). For example, Alice may generate (e.g., privately) a message1 “aliceBTC” and Bob may generate (e.g., privately) a message1′ “bobETH.” FIG. 15 depicts example messages, including example threshold shares for Alice's ETH asset (e.g., see messages depicted at blocks 1501, 1502, and 1503) and example threshold shares for Bob's BTC asset (e.g., see messages depicted at blocks 1504, 1505, and 1506) and further including an example message depicted at block 1506.

As mentioned above in connection with block 1404 of example process 1400 (e.g., a protocol), in implementations, multiple instances of a particular protocol, wherein individual instances of the protocol may include Re-encryption Key Validation (see example process 1800 depicted in FIG. 18) and Message Validation and Delivery (see example process 1900 depicted in FIGS. 19-20). A first instance of the protocol, including example processes 1800 (Re-encryption Key Validation) and 1900 (Message Validation and Delivery), may be performed based at least in part on the Initial Threshold Homomorphic Keypairs depicted in FIG. 16 and a second instance of the protocol may be performed based at least in part on the “prime” (e.g., “′”) variants of the Initial Threshold Homomorphic Keypairs depicted in FIG. 17. Various example keypairs and/or messages corresponding to operation 1402 are depicted at self-explanatory blocks 1601-1622 of FIG. 16. Further, example keypairs and/or messages corresponding to operation 1403 are depicted at self-explanatory blocks 1701-1722 at FIG. 17. In implementations, the first and second instances may be performed concurrently and/or in a parallel fashion. In implementations, the first and second instances may be interleaved (e.g., on an operation-by-operation basis), such that Alice may control “alice” and “bob′” keys and Bob may control “bob” and “alice” keys. Charlie may control both variants of “charlie” keys, for example. Of course, subject matter is not limited in scope in these respects.

In an implementation, example processes 1800 and 1900 may be implemented, at least in part, as two respective files, for example. For example, in an implementation, operations of FIG. 18 may comprise a first file and the operations of FIG. 19 and FIG. 20 may comprise a second file. Again, subject matter is not limited in scope in this respect.

In accordance with numerals 1, 2 and 3 depicted in FIGS. 18-20, an example protocol (e.g., see block 1404 of FIG. 14a) may jump between FIG. 18-20 under particular example circumstances, as shown. Also, in FIGS. 18-20, a number of indicator arrows denoting respective operations (e.g., op1, op2 . . . op37) are depicted. Although a particular ordering of operations may be suggested by such indicators, subject matter is not limited in scope in theses respects. Also, it should be noted that the example protocol including example re-encryption key validation process 1800 and/or example message validation and delivery process 1900 may be terminated for various reasons, including, but not limited to, particular results of various test operations shown in FIGS. 18-20. For example, a failure of any of the various verification tests may result in termination of the example process and implementation logic may punish whichever party has been determined to comprise a liar or truant, in an implementation.

For any three parties, Alice, Bob, and Charlie, in performing operations pertaining to re-encryption key validation process 1800 and/or message validation and delivery process 1900, not only may Alice apply the logic for herself as Alice, but she may also run a separate instance of the processes again switching places with Bob. Bob and Charlie may also participate in Alice's 2nd instance. Alice, Bob, and/or Charlie may each utilize collateral locked into the contract during the moments before, during, and for some amount of time (e.g., smaller amount of time) after the completion of operations pertaining to re-encryption key validation process 1800 and/or message validation and delivery process 1900. Ratios between parties, amounts of and/or types of collateral may comprise parameters that may be selected based at least in part on particular implementation decisions. Also, in an implementation, the second instance may be executed concurrently, at least in part, with the first instance in an interleaving manner, for example.

In an implementation, at points shown with numbered circles (e.g., circles labeled 1, 2 and/or 3 which may indicate a switch to a different FIG. at the same point), both instances of the protocol (e.g., processes 1800 and 1900) may be completed up to that point. In an implementation, both instances must be completed up to that particular point, for example.

Also, for example, a definition of Timely Manner (e.g., measured in blocks, minutes, etc.) may be implemented. A punishment function may also be implemented, for example. In an implementation, a punishment function may transfer collateral (e.g., in a deterministic manner) from truants and/or liars to those who are not determined to be truants and/or liars.

In implementations, operations of example re-encryption key validation process 1800, including, for example, N(orthern) Algorithm and/or S(outhern) Algorithm, may comprise a verifiable secret sharing algorithm for a wide range of applications (e.g., any application), such as for elliptical curve shares and/or the like, for example.

Further, implementations of re-encryption key validation process 1800 and/or message validation and delivery process 1900, for example, may include a re-encryption algorithm (see example 2610 of FIG. 26) and/or process having an ability to perform proxy re-encryption (PRE) with an encrypted re-encryption key, for example. This may comprise a key that may be generated and/or encrypted by a message sender using a proxy's public key (e.g., referred to as H-PRE, or homomorphic proxy re-encryption). This may also be accomplished using multihop encryption (e.g., with two hops, Alice to Charlie and Charlie to Bob), but a re-encryption algorithm and/or process may be more secure because, with multihop, a proxy can decide to send a garbled message and blame it on the message sender, and alternatively a sender may send a garbled message and blame it on the proxy. Typically a server may handle such verification in traditional proxy re-encryption by adding an authentication layer to the encryption.

Implementations of re-encryption key validation process 1800 and/or message validation and delivery process 1900, for example, may include a process for anonymously verifying correctness of a PRE key, for example.

Implementations may further comprise a decrypt process (see example 2710 of FIG. 27), including, for example, an ability to undo both layers of encryption (sender and proxy) using just the proxy's secret key (they can't lie about this, their key is either correct or not). This may comprise a computationally verifiable authentication which does not rely on a server and/or which may directly create a method for the proxy to exonerate themselves against false claims of interference by a message sender. For example, if the secret key belongs to the proxy's public address, the message sender did not send the correct message, did not encrypt their re-encryption key to the correct proxy public key, and/or maliciously garbled the message. If the secret key is not shared or is wrong, then the proxy garbled the message to the receiver, for example.

In an implementation, example re-encryption key validation process 1800 (refer again to operation 1404 of FIG. 14) may begin at the block labeled “start here” in FIG. 18. As indicated at blocks 1801, 1802, and 1803 (e.g., operation (op) 1), Alice may encrypt (e.g., privately) Alice's private re-encryption key “REA3A2” with key alice4 to produce “EnREA3A2”. As indicated by the particular key-coding (dotted outline, in this case), EnREA3A2 (previously privately encrypted under alice4) may be made public (e.g., by Alice), such as being placed on a blockchain and/or some other public environment, for example.

As further indicated in FIG. 18, responsive at least in part to EnREA3A2 being made public, operation 2 (op2) indicates that Charlie may make public (e.g., reveal) the private components of key “charlie1” (see block 1804). Thus, both the public and private aspects of the keypair charlie1 are publicly visible. As additionally indicated by operation 3 (op3) and/or the short dash coded block 1805 (“test charlie1”), an operation may be performed to test whether charlie1 is valid. For example, a known plaintext string (e.g., “sample”) may be encrypted with the public key of the charlie1 public/private keypair and then may be decrypted using the revealed private key of the charlie1 public/private keypair. In implementations, anyone may perform the validation, as indicated by the short dash outlining, for example. In an implementation, “sample” may be randomly generated via a code function. For example, whenever such a code function is called a new randomly-generated string may be returned. For the purposes of this explanation, the randomly-generated string is labeled “sample.”

If the validation of charlie1 does not succeed, then it may be determined that Charlie did not provide valid content (e.g., Charlie “lied”), and the example process (e.g., process 1404) may terminate, as indicated. However, responsive at least in part to a successful validation of charlie1, operation 4 indicates that a vector of ciphertext may be passed (e.g., string “sample” encrypted under alice4). See block 1806. Further, for example, operation 5 indicates that random string “sample” may be further encrypted (e.g., under the alice3 key) to produce encrypted sample “ctsample” as shown at block 1807. That is, ctsample may be encrypted under alice4 as an outer layer of encryption and may be double-encrypted under alice3 as an inner layer. In implementations, a designation of “ct” at the beginning of a label may indicate a ciphertext. Thus, for example, “ctsample” may comprise an encrypted version of string “sample.”

Additionally, in an implementation, operation 6 may indicate that the ctsample may be re-encrypted utilizing a ReEncryption( ) operation (see, for example, process 2610 of FIG. 26). See block 1808. In an implementation, the re-encryption may include encryption of ctsample from alice3 to alice2 based at least in part on the encrypted re-encryption key EnREA3A2 (previously encrypted under alice4—see operation 1). As mentioned, ctsample may have been previously encrypted under alice4 as an outer layer of encryption. In implementations, the object to be encrypted and the re-encryption key may have identical outer layers (e.g., alice4).

As indicated by operation 7 and as depicted at block 1809, a re-encrypt key “REA4A6” (e.g., from alice4 to alice6) may be utilized to re-encrypt ctsample to change its outer layer of encryption from alice4 to alice6. Note that REA4A6 may be generated as depicted in the initial threshold homomorphic keypair generation operation depicted, for example, in FIG. 16. In an implementation, changing the outer layer, such as from alice4 to alice6, may be done, at least in part, to allow testing of a different “charlie” key (e.g., charlie3). As noted, charlie1 was previously tested under alice4, and subsequently charlie3 is tested under alice6. As will be discussed below, charlie2 will be tested under alice5.

As further indicated, such as at block 1810, operation 8 (op8) may include a partial decryption of ctsample based on the alice6 key. As indicated by the particular key-coding (long dash outline, in this case), this partial decryption may be performed privately with respect to Alice. Additionally, operation 9 (op9) may result in a reveal of the partially decrypted ctsample followed by a reveal of the private key of the charlie3 keypair, for example, as indicated at block 1811. As mentioned, “reveal” in this context refers to making a particular object at issue visible publicly (e.g., placed on a blockchain).

In an implementation, operation 10 (op10) may include a test of the charlie3 keypair (see FIG. 16). As indicated by the key-coded (long dash outline) block 1812, an operation may be performed to test whether charlie3 (e.g., provided by Charlie) is valid. In an implementation, a known plaintext string (e.g., randomly generated “sample”) may be encrypted with the public key of the charlie3 public/private keypair and then may be decrypted using the revealed (see op9) private key of the charlie3 public/private keypair. As indicated by the short dash outline, anyone may perform the validation.

If the validation of charlie3 does not succeed, then it may be determined that Charlie did not provide valid content (e.g., Charlie “lied”), and example process 1800 may terminate, as additionally indicated at block 1812. However, responsive at least in part to a successful validation of charlie3, operation 11 (op11) indicates that a vector of ciphertext “ctsample” may be decrypted (e.g., Decrypt—see 2710 of FIG. 27) using the revealed charlie3 private key to produce “ctsampleA2” which may comprise a ciphertext under alice2. See block 1813, for example. In an implementation, this decryption may remove the outer layer of encryption, leaving the inner layer of encryption under alice2 (e.g., refer to the ReEncryption of ctsample at operation 6).

With respect to operation 12 (op12) depicted in FIG. 18, ctsampleA2 may be re-encrypted (e.g., ReEncryption—see 2610 of FIG. 26) using a privately encrypted (e.g., private to Alice) ReEncrypt key REA2PP (e.g., from alice2 to public pair), wherein REA2PP is encrypted under alice5. See block 1814. The results of operation 12 may yield a double-encrypted ciphertext “ctsamplepp” having an inner layer of encryption under a public pair key (see FIG. 16) and an outer layer of encryption under alice5. It may be noted that the encryption of REA2PP under alice5 happens privately (under Alice's control), and the re-encryption of ctsampleA2 using the encrypted REA2PP key to produce ctsamplepp occurs publicly as denoted by the dotted outline key-coding.

As further indicated, operation 13 (op13) may include a partial decryption of ctsamplepp based on the alice5 key. As indicated by the particular long dash outline key-coding of block 1816, this partial decryption may be performed privately with respect to Alice. Additionally, as depicted at block 1817, operation 14 (op14) may result in a reveal of the partially decrypted ctsamplepp followed by a reveal (e.g., made public, such as placing on blockchain) of the private key of the charlie2 keypair, for example.

Further, for example, operation 15 (op15) may include a test of the charlie2 keypair. As indicated by the short dash outline key-coded block 1818 (“test charlie2”), an operation may be performed to test whether charlie2 (e.g., provided by Charlie) is valid. In an implementation, a known plaintext string (e.g., randomly generated “sample”) may be encrypted with the public key of the charlie2 public/private keypair and then may be decrypted using the revealed (see op14) private key of the charlie2 public/private keypair. As again indicated by the short dash outline key-coding of block 1818, anyone may perform the validation.

If the validation of charlie2 does not succeed, it may be determined that Charlie did not provide a valid charlie2 keypair, and example process 1800 may terminate, as indicated, again, at block 1818. However, responsive at least in part to a successful validation of charlie2, operation 16 (op16) indicates that a decryption of ctsamplepp using the revealed charlie2 private key may produce “ctsamplepp” which may comprise a ciphertext under the public pair key. See block 1819. In an implementation, this decryption may remove the outer layer of encryption (e.g., alice5), leaving the inner layer of encryption under public pair.

Further, operation 17 (op17), for example, may indicate that decrypted ctsamplepp (e.g., ciphertext under public pair) may be made publicly available, such as on a blockChain, for example. See block 1820. Also, in an implementation, ctsamplepp may be decrypted using the public pair key, as indicated by operation 18, to generate a verification bits array labeled “sampleFHE.” See block 1821.

As noted in the glossary depicted in FIG. 14, a dashed straight line may signify that the two objects/states joined by the dashed straight line should be equivalent. For example, if all of Alice's keys utilized throughout example process 1800 are valid (and if the charlie1, charlie2 and/or charlie3 tests did not result in termination of the process), the string “sampleFHE” decrypted/revealed at operation 18 (see block 1821) should be equivalent to the string “sample” that was randomly generated in connection with the operation to test charlie1. As depicted in FIG. 18, an operation to verify that the two strings sampleFHE and sample are equivalent may be labeled as operation 19. In implementations, this verification may be performed by anybody (e.g., may be verified publicly). As mentioned, if the two strings are found to be not equivalent, then it may be determined that one or more of the keys provided by Alice (e.g., alice4, alice5, REA2PP and/or REA3A2) is not valid (e.g., Alice lied). See block 1822. If the two strings are determined to not be equivalent, process 1800 may be terminated, for example. However, if the two strings are found to be equivalent, it may be determined that the keys provided by Alice are valid and, as indicated by the circle labeled “1,” the protocol may jump to example process 1900 depicted, at least in part in FIG. 19.

As mentioned, example process 1800 is directed generally to testing some of Alice's keys and Charlie's keys that were initially generated as depicted in FIGS. 16-17. Thus, as was also mentioned, process 1800 may be referred to as a “re-encryption key validation” process. In a similar vein, example process 1900 may be directed generally to validating a message (see block 1901), such as message1 (e.g., digital asset threshold key share) depicted in FIG. 16.

In implementations, example process 1900 may generally include a S(outhern) Algorithm (S-Algo) performed privately (e.g., by Alice) to generate message metadata. See block 1902. As mentioned previously, S-Algo may include a set of operations, algorithms, etc. to match a private component of a message (e.g., private key) to a public identifier (e.g., public key) for the message in cleartext. As indicated by the particular dotted outline key-coding of block 1902, results of the S-Algo may be made public (e.g., metadata accessible via public key). In general, because a second party (e.g., Bob) can't verify the S-Algo performed privately, a public version similar to the S-Algo may be performed. This public version may be referred to as a N(orthern) Algorithm (N-Algo). See discussion below in connection with FIG. 21 for more details related to N-Algo. In general, message metadata generated via the private S-Algo and a version generated via the more public N-Algo, for example, may be compared with each other as indicated at operation 28 (see block 1912). If the two versions of the message metadata matches, other party (e.g., Bob) can be assured that message metadata can be trusted.

Turning to operation 20 depicted at block 1903, message1 (e.g., message privately generated by Alice) may be encrypted, and the encrypted message shown at block 1904 may be made publicly visible (e.g., stored in aa specified public environment such as a blockchain). As indicated, a first portion (e.g., private keys) of the message may be encrypted with the alice3 key and another portion (e.g., other sensitive content) may be encrypted with the alice8 key, for example. Again, see FIG. 15 for an example message (e.g., message 1506). Further, in an implementation, operation 21 (op21) indicates that the encrypted message hash may be re-encrypted with REA3A8 such that the message hash may now be encrypted under alice8 rather than alice3. See block 1905, for example.

In an implementation, a N(orthern) Algorithm (N-Algo) may be performed on the encrypted message hash, as indicated at operation 22 (op22). As mentioned, N-Algo may comprise a publicly-performed algorithm that may be similar in at least some respects to S-Algo. Also, for example, N-Algo may comprise a homomorphic version of S-Algo. Again, see FIG. 21 and the associated discussion below for additional details regarding N-Algo and example operation 22. In an implementation, operation 22, including the N-Algo, may result in message hash metadata encrypted under alice3, for example, as shown in block 1906. As indicated by the particular short dash outline key-coding of block 1906, generation of the encrypted message hash metadata may be computationally publicly verifiable (e.g., anyone can perform the operation, anyone can verify the operation).

As additionally indicated at operation 23, the encrypted hash message (e.g., previously encrypted under alice8 at operation 21) may be partially decrypted using the alice7 and alice8 keys. As indicated by the particular long dash outline key-coding of block 1907, operation 23 may be performed privately under the control of Alice. At operation 24, for example, Alice may submit the partially decrypted hash message to the public environment (e.g., blockchain, server, etc.). As indicated by the particular dotted outline key-coding of block 1908, partial decrypts under alice7 and alice8 may be revealed. Key bob1 may also be revealed, for example.

As further indicated at operation 25 and its associated short dash outline key-coded block 1909, bob1 may be tested. In an implementation, a known plaintext string (e.g., sample) may be encrypted with a public aspect of the bob1 keypair. The string may subsequently be decrypted utilizing a private aspect of the bob1 keypair. For circumstances in which the decrypted string matches the initial plaintext string, bob1 may be determined to be valid. Should the strings not match, then the validation of bob1 may be determined to have failed, and process 1900 may terminate, for example.

At operation 26, in an implementation, the partial decryptions (e.g., for alice7 and alice8) for the encrypted message metadata may be made publicly known and/or verifiable, along with the bob1 keys. See block 1910. Note that keys alice7 and alice8 are themselves kept private (e.g., under control of Alice), while the decrypts based on those keys are made public, for example.

As indicated at operation 27, a multiparty decryption of the encrypted message metadata may be accomplished utilizing, at least in part, the partial decrypts for alice7, alice8 and/or bob1. A decrypt fusion function may combine the various partial decrypts to produce message metadata FHE (“MMFHE”), as indicated at block 1911.

In implementations, as indicated at operation 28 (see block 1912), for circumstances in which the various submitted objects (e.g., alice2, alice3, alice7, alice8, the message, etc.) are valid, MMFHE should match message metadate “MM” generated by the S-Algo previously mentioned. That is, if MMFHE and MM match, then it may be determined that keys alice2, alice3, alice7, alice8 and so forth are valid. In an implementation, anyone may perform the validation check (e.g., matching check may be publicly computationally verifiable). Also, in an implementation, a signature verification operation (e.g., ECC signature verification function) may be utilized to verify that MMFHE matches MM, for example.

As mentioned, in general, message metadata generated via the private S-Algo and a version of the message metadata generated via the more public N-Algo, for example, may be compared with each other as indicated at operation 28 of block 1912. If the two versions of the message metadata match, other party (e.g., Bob) can be assured that message metadata can be trusted.

Turning now to the circled “2” in FIG. 20, a re-encrypt key REA4C4 (e.g., may be utilized to re-encrypt an object from alice4 to charlie4) is shown. As indicated by the particular long dash key-coding of block 2001, REA4C4 may be initially generated privately under Alice's control. See FIG. 16, for example. Further, as indicated at operation 29 (op29), re-encryption key REA4C4 may be revealed. See block 2002. As mentioned previously, “revealed” in this context refers to pubic and private aspects of a particular keypair may be made public, such as placed in a specified public environment (e.g., blockchain, server, etc.). Further, operation 30 indicates that charlie4 may be revealed (see block 2003), and operation 31 indicates that charlie4 may be tested (see block 2004). Testing of charlie4 may be performed in a manner similar in at least some respects to previously-described tests of Charlie's keys (e.g., charlie1, charlie2, charlie3). For example, in an implementation, a known plaintext string may be encrypted with the charlie4 public key and may be decrypted with the charlie4 private key. As indicated, if the test of charlie4 fails, Charlie may be determined to have provided invalid keys (e.g., Charlie lied) and the protocol (e.g., process 1900) may be terminated.

Responsive at least in part to a successful test of charlie4, encrypted re-encryption key EnREA3A2 may be again encrypted under charlie4 to yield key “REREA3A2” as indicated by operation 32. See block 2005. As further indicated by operation 33, re-encryption key “REA4C4” may be tested. See block 2006. For example, a known plaintext string may be encrypted with the alice4 public key and then re-encrypted with REA4C4. The encrypted and then re-encrypted string may then be decrypted with the charlie4 private key. If the decrypted version (e.g., decrypted with the charlie4 private key) matches the version of the string encrypted with the alice4 public key, then REA4C4 may be determined to have passed validation. Otherwise, it may be determined that Alice lied about REA4C4 and process 1900 may terminate, for example.

As indicated at operation 34, REREA3A2 may be decrypted. See block 2007. It may be remembered that REA3A2 was previously encrypted under alice4 (see operation 1 and block 1802) and then re-encrypted under charlie4 (see operation 32 and block 2005). Therefore, REREA3A2 may be decrypted at least in part by applying key REA4C4 to change REREA3A2's encryption status from alice4 to charlie4 and then by applying charlie4 to yield REA3A2, now visible to the public as indicated by the particular dotted outline key-coding of block 2007.

At this point in the example protocol including processes 1800 and 1900, it may have been determined that the message privately generated by Alice is valuable and that re-encryption key REA3A2 is valid. Subsequently, as further indicated at operation 35, the encrypted message 1904 (e.g., encrypted message generated at operation 20 depicted at FIG. 19, labeled with a circle “3”) may be re-encrypted under alice2 to generate re-encrypted message “ReM” as depicted at block 2008, in an implementation. Further, in an implementation, operation 36 (op36) may include Bob privately re-encrypting encrypted message ReM under bob2 utilizing the REA2B2 key. See block 2010. It may be noted that REA2B2 was previously generated as part of the initial threshold homomorphic keypairs depicted in FIG. 16, and that REA2B2 was privately generated under Bob's control.

As a result of operation 36, re-encrypted message ReM may now be encrypted under bob2. See block 2009. Bob may, utilizing the bob2 keypair, decrypt re-encrypted message ReM to produce a decrypted message, as indicated at operation 37 and block 2011. Due at least in part to the various operations (e.g., encryptions, decryptions, re-encryptions, validation checks, etc.) of processes 1800 and/or 1900, message 2011 generated at operation 37 should be a valid and complete copy of original message 1901 generated and/or provided by Alice (e.g., Maker). In this manner, for example, a valuable message, such as example message 1506 depicted in FIG. 15, may be securely transferred to Bob (e.g., Taker), with Charlie acting as a validator.

As mentioned, messages may be communicated from Alice to Bob, for example, via a first instantiation of processes 1800 and 1900 as described above. In an implementation, messages may be communicated from Bob to Alice, for example, via a second instantiation of processes 1800 and 1900 utilizing the initial threshold “′” homomorphic keypairs depicted in FIG. 17. In implementations, the two instances of processes 1800 and 1900 may be performed concurrently and/or in tandem, at least in part. Also, in an implementation, the two instances of processes 1800 and 1900 may be interleaved (e.g., on an operation-by-operation basis) with Alice controlling the “alice” and “bob′” keys and with Bob controlling the “bob” and “alice′” keys. Charlie may maintain control of both variants of the “charlie” keys.

In implementations, one or more parties refusing and/or otherwise failing to provide requisite and/or appropriate content for a particular operation of processes 1800 and/or 1900, for example, within a specified period of time may result in a termination condition (e.g., TERMINATE PROTOCOL), wherein process 1800 and/or process 1900 may be terminated. See, again, block 1404 of FIG. 14a. Termination may also result from malicious falsification and/or submission of content (e.g., keys, messages, etc.), for example. In the event of a default or misconduct (e.g., absence or lies) that may trigger a TERMINATE PROTOCOL condition and/or the like, each party not responsible for the TERMINATE PROTOCOL condition may message the server, for example, to send the other parties' (e.g., Bob's or Alice's) previously submitted key (see FIG. 15).

As indicated at block 1405 of FIG. 14a, following completion of an exchange of assets, such as described above, an asset exchange protocol may be finalized at least in part via deletion of each parties' previously submitted keys, in an implementation.

FIG. 21 depicts an embodiment 2100 of an example N(orthern) Algorithm (N-Algo) process. In implementations, example process 2100 and/or the like may be utilized in message validation and/or delivery operations, such as discussed above in connection with example process 1900 (see, for example, operation 22), for example. Embodiments may include all of the operations described, fewer than the operations described, and/or more than the operations described in example process 2100. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

For example process 2100, a “verifier” may comprise a semi-trusted party that runs the protocol, while making request to other parties. In an implementation, the verifier may be assumed to be honest and/or ciphertexts a verifier publishes may be taken at face value. Also, in an implementation, a “peeker” may comprise a semi-trusted party that may be allowed to view decrypted plaintexts but is not assumed to be honest. For example, a peeker may be trusted to keep content private, but they may not be trusted to verify anything. In implementations, “validators” may comprise parties that individually (e.g., each) hold a threshold key pair and/or that may provide an encrypted input such as En(A) or En(B). Validators may represent more than one individual/party, but for the sake of the present example a single validator distinct from the verifier may be assumed. In connection with example processes 1800 and 1900 described above, N-algo process 2100 may include Charlie as a verifier. Also, for a first instance of processes 1800 and 1900, N-algo process 2100 may include Alice as a peeker and Bob as a validator. For a second (e.g., concurrent) instance of processes 1800 and 1900, N-algo process 2100 may include Bob as a peeker and Alice as a validator, for example.

As depicted in FIG. 21, example process 2100 may be partitioned into several parts. For example, part 1 (Setup) may describe a setup phase of an N-algo (e.g., process 2100), wherein a) resources may be negotiated and/or agreed on and b) inputs may be prepared. Also, for example, part 2 (Arithmetic) may describe an arithmetic phase of an N-Algo (e.g., process 2100), wherein operations may be performed on encrypted integers (e.g., big integers) represented by the Residue Number System, for example. Interactivity may be leveraged to ensure values remain within plaintext limits. Part 3 (Reduction), for example, may describe a reduction phase of an N-Algo (e.g., process 2100), wherein a reduced result may be computed from a sensitive nonreduced result. The reduced result may subsequently be revealed. In an implementation, the modulus we reduce by in this part 3 may be arbitrarily selected at any time. It may be noted that, in an implementation, the modulus P may be selected to be within the Residue Number System.

### Glossary (e.g., Pertaining to Example Process 2100)

The following glossary may aid in understanding example process 2100.

bitTest( ) [ComputePeekerProofs( )] may comprise a function that may verify that it's numerical input, x, is an array of bits (e.g. [0, 1, 0, etc . . . ]) at least in part by passing the following tests, for example: x\hat{ }4−x\hat{ }2=0, x\hat{ }2−x=0, and −0.25 x\hat{ }10−0.25 x\hat{ }9+1 x\hat{ }6+1 x\hat{ }5−0.5 x\hat{ }4−0.25 x\hat{ }3−1 x\hat{ }2−0.75 x+1 x=0.

Residue Number System (RNS) may comprise a numeral system representing integers by their values modulo several pairwise coprime integers called the moduli. This representation is allowed by the Chinese remainder theorem, which asserts that, if M is the product of the moduli, there is, in an interval of length M, exactly one integer having any given set of modular values. The arithmetic of a residue numeral system may also be referred to as multi-modular arithmetic. RNS may comprise a methodology for expressing (e.g., easily expressing) integers as vectors of smaller integers (residues), while preserving addition and multiplication about a large modulus. It may be useful because relatively very large integers (e.g., over 64 bits) may be unwieldy in computations and/or outright cannot be used easily and reliably in computations in a number of programming languages without precision errors. Access to arithmetic operations may also be restricted to integers of specific size and no larger, in which case RNS may be used to bypass such restrictions.

Chinese Remainder Theorem RNS (CRT RNS). The Chinese Remainder Theorem-based RNS is an RNS which encodes integers (especially larger ones, e.g., over 64-bit size) as an array of other integers modulo another vector of prime integer moduli. The elements in this array are mathematical objects called residues. While the elements of the moduli vector are not required to be prime, it is a requirement that the elements be coprime to each other (this is a requirement of all RNS). Thus it is simpler to just use a vector of primes. Any number of arithmetic operations can be performed (e.g., from the set of addition, subtraction and multiplication) on the CRT RNS encoded integer with other CRT RNS encoded integers provided, for example: the resultant integer is not larger than the product of all of the elements of the moduli vector, and neither CRT RNS encoded integer is larger than the product of all elements of the moduli vector.

For example:
For some vector of moduli, M,=[3, 5, 7, 11], <=all are unique primes, this is the easiest way.
The product of the moduli, P, is 3*5*7*11=1155
Choose some integer, A, and let it=16 which is <1155.
To CRT RNS encode, we simply produce the vector A mod M=[A mod 3, A mod 5, A mod 7, A mod 11]=[1, 1, 2, 5]
Choose some other integer B, and let it=9 which is <1155, the CRT RNS encoding, B mod M=[0, 4, 2, 9]
Then A*B=[1, 1, 2, 5]*[0, 4, 2, 9]=[0, 4, 4, 45]. We also know A*B=144, but how do we produce that from [0, 4, 4, 45] ?
To get the integer form of A*B, simply follow the Chinese Remainder Theorem (see below)

Chinese Remainder Theorem states that knowing the remainders of an integer against a vector of coprime moduli is sufficient to recover said integer mod the product of the moduli

Threshold Keys may comprise public, private, and/or evaluation keys for use in a secure multiparty computation. These keys may be jointly negotiated by all parties involved. The public and evaluation keys may be shared with everybody. The public keys may be used to encrypt, and the evaluation keys may be used to perform arithmetic consisting of encrypted addition, encrypted multiplication, and/or encrypted vector rotation. The private keys may be used to jointly decrypt, wherein each party privately computes a partial decryption, and then these partial decryptions may be publicly joined to form a decrypted plaintext.

Nonreduced Ciphertext. To perform addition or multiplication in a Residue Number System, one may simply perform addition or multiplication on each of the residues. Reducing each residue about the modulus is an optional step—the congruence class is all that matters in terms of correctness. However, when operating within a fixed plaintext modulus, reducing the residues may prevent residues from continually growing and eventually overflowing the plaintext modulus. Similarly, legal values are user-supplied RNS ciphertexts which should be already reduced. If these ciphertexts were not reduced, then users may be able to trigger errors via overflow.

Homomorphic Encryption schemes such as BGV and CKKS, for example, may provide the capability to evaluate addition, multiplication, and/or vector rotation on encrypted values. Example process 2100 may use leveled somewhat homomorphic encryption, wherein there may be a fixed limit to the number of consecutive operations (e.g., mostly bounded by multiplication) that can be performed on ciphertexts.

// The “//” symbol represents flooring division. That is, 5//2=2.

P The arbitrary modulus, P, represents the large modulus that we reduce by in part 3. That is, P may be large (e.g., larger than the moduli of the RNS system), and as such, may be represented across multiple slots.

Returning to example process 2100 (N-Algo), it may be noted that FIG. 21 provides a key code 2115 for the various blocks denoting the particular actors/parties that perform the various operations. For example, as indicated, the short dash outline key-coded blocks indicate that the operation may be performed, at least in part, by the public (e.g., anybody can perform and/or verify and/or the operations may be performed within a public environment such as a blockchain, server, etc.). Also, for example, the dot-dot-dash outline key-coded blocks indicate action by a verifier. The dot-dash outline key-coded blocks indicate peeker action and the long dash outline key-coded blocks indicate action by a validator, for example.

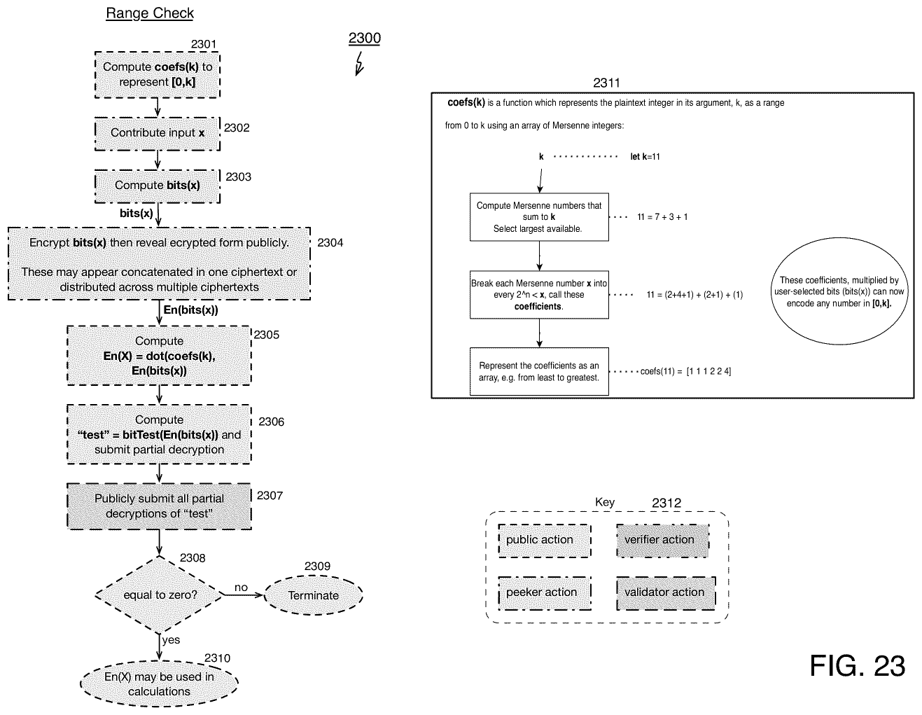

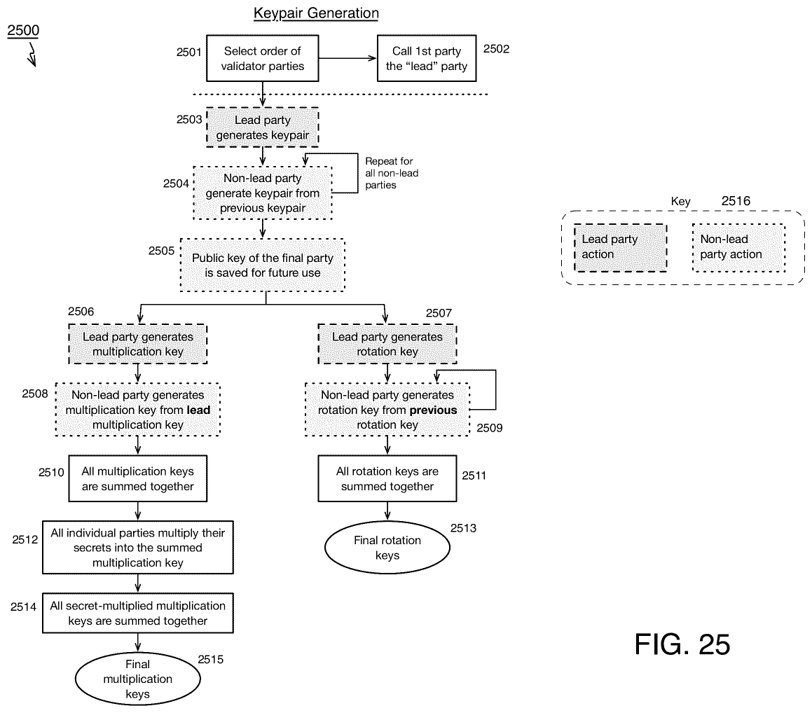

Part 1 (Setup) includes operations 2101-2104. As indicated at operation 2101a, for example, participating parties may agree on some kind of simple arithmetic function, S, to compute on encrypted integers (e.g., A, B, C, D, of any size), such as S=(A*B+C)*D. A modulus, P, is also decided. In implementations, as indicated at operation 2101b, validators may negotiate a set of threshold keys (see Keypair Generation, FIG. 25) for encryption, evaluation and/or decryption. In implementations, operations 2101a and 2101b may be performed substantially concurrently, for example. Further, at operation 2102, validators may submit encrypted CRT RNS inputs, such as En(A), En(B), En(C), En(D) (note: unencrypted inputs may also exist but are omitted here for brevity/clarity). As additionally indicated at operation 2103, a verifier may compute “test ciphertexts” which assert that supplied encrypted inputs are within the RNS (See Range Check, FIG. 23). Operation 2104 indicates that validators jointly decrypt “test ciphertexts” and that the verifier broadcasts that the proof passes, for example.

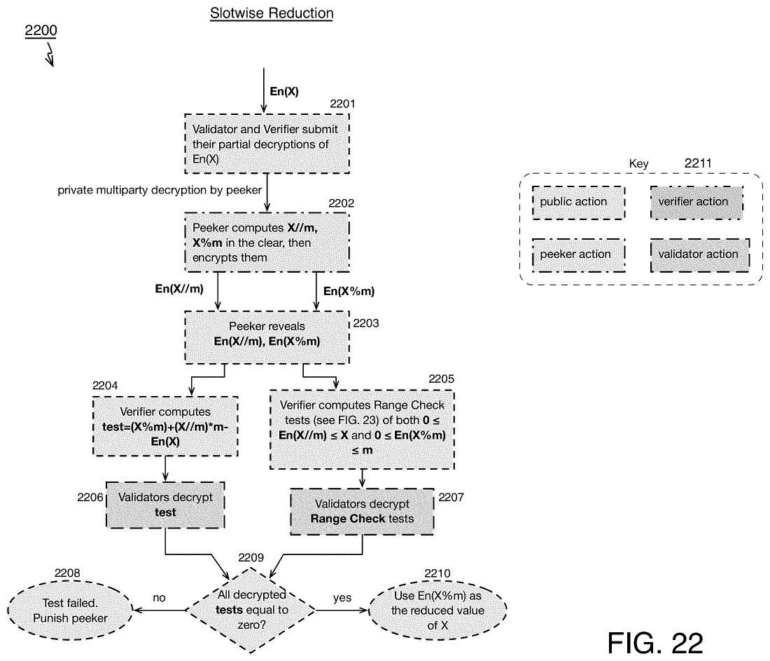

Part 2 (Arithmetic) of process 2100 (N-Algo) includes operations 2105-2109. As indicated at operation 2105, a verifier computes nonreduced intermediary results, such as: En(AB)=En(A)*En(B). At operation 2106, for example, validators partially decrypt intermediary results En(AB) and at operation 2107 the peeker may see decrypted AB and may submit En(AB_reduced) back to the verifier, in an implementation. Further, as indicated at operation 2108, the verifier computes “test ciphertext” of En(AB_reduced) and submits to validators (see Binary Decomposition, FIG. 22), for example. As indicated at operation 2109, validators may jointly decrypt “test ciphertext” and the verifier may broadcast that the proof passes, in an implementation. Part2 may include returning back to operation 2105 for all other arithmetic operations in S on remaining inputs (in this case, En(AB)+En(C)=En(ABC) and En(ABC)*En(D), for example).

Part 3 (Reduction) of process 2100 (N-Algo) includes operations 2110-2113. In an implementation, as indicated at operation 2110, validators may partially decrypt final result S and may send the results to the peeker. As indicated at operation 2111, the peeker submits (En(S/P), En(S mod P)) to the verifier, for example. Further, as indicated at operation 2112, the verifier computes “test ciphertext” of En(S/P) and En(S mod P), verifying that they are a) legal values and b) represent En(S), for example. As further indicated at operation 2113, for example, the validators may jointly decrypt “test ciphertexts” and the verifier broadcasts that the proof passes.

In implementations, example process 2100 may include operation 2114, wherein, as indicated, everybody may decrypt En(S mod P).

FIG. 22 depicts a flow diagram illustrating an embodiment 2200 of an example binary decomposition process. Embodiments may include all of the operations described, fewer than the operations described, and/or more than the operations described in example process 2200. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features. Also, it may be noted that the key-coding provided in FIG. 22 may be similar to that provided in FIG. 21.

In implementations, example process 2200 (Binary Decomposition) may address, at least in part, the problem: given a ciphertext encoding an array of integers En(X), how can one verifiably homomorphically compute elementwise another array En(Y)=En(X) % M for some array of moduli M. For example process 2200, “%” represents a modular reduction operator, “//” represents a floored division operator, and “m” is shorthand for the moduli.

In general, for example process 2200 (Binary Decomposition), if En(X) represents the residues of a number, then reducing En(X) by the moduli will prevent slots from growing towards the plaintext modulus without semantically altering the residues.

As indicated at block 2201, a validator and a verifier may submit their partial decryptions of En(X). As further indicated by the particular key-coding of block 2201, this operation may be performed publicly. Additionally, as indicated by the arrow between block 2201 and block 2202, the peeker may perform a private multiparty decryption, in implementations.

In implementations, the peeker may compute X//m, X % m in the clear, then encrypts them (e.g., yielding En(X//m) and En(X % m), respectively), as indicated at block 2202. Further, as indicated by the particular dot-dash outline key-coding, the encryption of X//m, X % m may be performed privately under the peeker's control.

As indicated at block 2203, the peeker may reveal En(X//m), En(X % m). As previously indicated, “revealed” in this context refers to being made public, such as placed in a specified public environment (e.g., blockchain, server, etc.).

Further, as indicated at block 2204, the verifier may compute test=(X % m)+(X//m)*m−En(X), in an implementation. Also, for example, the validator(s) may decrypt test, as indicated at block 2206.

In an implementation, as indicated at block 2205, the verifier may compute Range Check tests (see example process 2300, FIG. 23) of both 0≤En(X//m)≤X and 0≤En(X % m)≤m. As further indicated at block 2207, the validator(s) may decrypt the results of the Range Check tests performed at block 2205, for example.

As indicated at block 2209, a determination may be made as to whether all of the decrypted test results from block 2206 are equal to zero, for example. As further indicated at block 2208, if any of the decrypted test results from block 2206 are not equal to zero, then test failed and the peeker may be punished. For circumstances wherein all decrypted test results are determined to be equal to zero, En(X % m) may be utilized as the reduced value of X, as indicated at block 2210.

FIG. 23 shows a flow diagram illustrating an embodiment 2300 of an example range check process. Embodiments may include all of the operations described, fewer than the operations described, and/or more than the operations described in example process 2300. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

In implementations, example process 2300 (Range Check) may address, at least in part, the problem: given a ciphertext En(X), where X[i] is an integer, how can one assert that X[i] is in {0,k} for some integer k without revealing any other information about X? That is, given a plaintext array X, how can we prove that X[i] is in [0,k] using only En(x)? In general, it may be advantageous to submit ciphertexts guaranteed to have a limited range in each slot, even in circumstances in which ciphertexts have the ability to store larger values. A ciphertext slot may comprise a location in a ciphertext that corresponds to a single plaintext integer smaller than a specific maximum value (e.g., within a specified range). A key 2312 is provided to aid in understanding the various example operations depicted at blocks 2301-2311. However, it may be noted that subject matter is not limited in scope to the particular operations and/or processes shown at blocks 2301-2311.

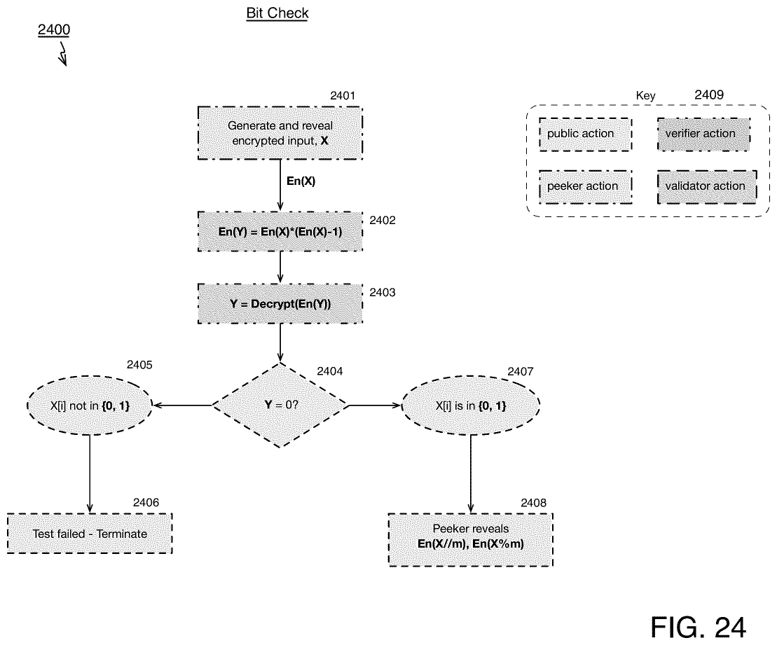

As will be seen below, example Range Check process 2300 may utilize a series of bit checks/tests. See example Bit Check process 2400 depicted in FIG. 24 and discussed below.

### Glossary (e.g., Pertaining to Example Process 2300)

The following glossary may aid in understanding example process 2300.

Mersenne Integer may comprise an integer of the form 2ⁿ−1 where n is also an integer.

dot(x,y) may comprise a function which is the dot product of its two array arguments. For example, dot(x,y)=sum from i=0 to i=n of x[i]*y[i], where n is the index of the last value of i. The arguments of x and y are of equal length, and may comprise vectors.

coefs(k) may comprise a function which represents the plaintext integer in its argument, k, as a range from 0 to k using an array of Mersenne integers. See FIG. 23 for an example in which k=11 and coefs(11)=[1 1 1 2 2 4].

bits(x) may comprise a function that produces a vector containing 1s and 0s, encoding the integer argument “x” which is greater than “−1” but less than some other integer “k” such that dot(coefs9k), bits(x))=x. for example, for 0<x<some strict upper bound, k: let k=11, then coefs(k)=[1 1 1 2 2 4], then bits(x)=[0 0 1 1 1 1] because 9=x=dotprod([1 1 1 2 2 4], [0 0 1 1 1 1])=(2*1+4*1+1*1)+(2*1+1*0)

Turning now to initial block 2301 of example Range Check process 2300, coefs(k) may be computed to represent [0,k], for example. Further, as indicated at block 2302, input x may be contributed. As indicated by the particular dot-dash outline key-coding of block 2302, x may be contributed by the peeker. In implementations, the peeker may also compute bits(x) as indicated at block 2303. As further indicated at block 2304, the peeker may encrypt bits(x) and may then reveal the encrypted form En(bits(x)) publicly, for example. As noted in block 2304, these may appear concatenated in one ciphertext of may be distributed across multiple ciphertexts, in implementations.

As indicated at block 2305, En(X)=dot(coefs(k), En(bits(x)) may be computed, for example. As indicated by the particular short dash outline key-coding of block 2305, En(X)=dot(coefs(k), En(bits(x)) may be computed via public action, in an implementation. Also, as indicated at block 2306, test=bitTest(En(bits(x)) may be computed and partial decryption may be submitted, in an implementation. Further, as indicated at block 2307, all partial decryptions of test may be publicly submitted. As indicated by the particular long dash outline key-coding for block 2307, public submission of all partial decryptions of test may be performed by the validator(s), for example.

Further, as indicated at block 2308, a determination may be made as to whether all partial decryptions of test are equal to zero. If not, then process 2300 may terminate at block 2309. If all partial decryptions are determined to be equal to zero, then En(X) may be utilized in calculations, in implementations.

FIG. 24 depicts a flow diagram illustrating an embodiment 2400 of an example bit check process. Embodiments may include all of the operations described, fewer than the operations described, and/or more than the operations described in example process 2400. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

In implementations, example process 2400 (Bit Check) may address, at least in part, the problem: given a ciphertext En(X) of integer encodings, how can one assert that X[i] is in {0,1} without revealing any other information about X? In general, it would be advantageous to submit ciphertexts guaranteed to only have bits in each slots (e.g., “0” or “1”), even when the ciphertexts have the ability to store other values. A key 2409 is provided to aid in understanding the various example operations depicted at blocks 2401-2408. Of course, subject matter is not limited in scope to the particular operations and/or processes shown at blocks 2401-2408.

As indicated at block 2401, and as further indicated by the particular dot-das key-coding, an input owner may privately generate X and may reveal encrypted form En(X). As further indicated at block 2402, En(Y) may be calculated. For example, En(Y)=En(X)*(En(X)−1). As indicated by the particular dot-dot-dash outline key-coding, En(Y) may be calculated by the verifier. The verifier may also decrypt En(Y). For example, Y=Decrypt(En(Y)), as indicated at block 2403.

Further, in implementations, a determination may be made as to whether Y=0. If any elements of Y are not equal to zero, then, as indicated at block 2405, X[i] is not in {0,1} and the bit check test failed. As indicated at block 2406, test failure may result in termination of the process. However, if Y is equal to zero in all aspects, then X[i] is in {0,1}, as indicated at block 2407. Further, in an implementation, the peeker may reveal En(X//m, En(X % m), as shown at block 2408, for example.

FIG. 25 is a flow diagram depicting an embodiment 2500 of an example Keypair Generation process. Embodiments may include all of the operations described, fewer than the operations described, and/or more than the operations described in example process 2500. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

In implementations, example process 2500 (Key Generation) may be directed, at least in part, to the challenge of negotiating a set of evaluation keys for use in multiparty settings. Such keys may be utilized for EvalMult( ) and EvalAtIndex( ), for example. EvalAdd( ) does not require key generation, in an implementation. A key 2516 is provided to aid in understanding the various example operations depicted at blocks 2501-2515. It may also be understood that subject matter is not limited in scope to the particular operations and/or processes shown at blocks 2501-2515.

For example process 2500 (Keypair Generation), “lead” indicates that a resource is obtained from the first party. “Previous” indicates that a resource is obtained from the party just before this party (e.g., to the third party).

As indicated at blocks 2501 and 2502, an order may be selected for the validator parties and the 1^{st} party may be referred to as the “lead” party. It may be noted that key 2516 depicted in FIG. 25 shows that short dash outlined key-coded blocks may indicate lead party action and dot outline key-coded blocks may indicate non-lead party action, in implementations.

At block 2503, for example, the lead party may generate a keypair. As further indicated at block 2504, a non-lead party may generate a keypair from a previous keypair. This action may be repeated for all non-lead parties, in an implementation. As further indicated at block 2505, a public key of the final party may be saved for future use, for example.

In an implementation, the lead party may generate a multiplication key, as indicated at block 2506, and may also generate a rotation key, as indicated at block 2507. As further indicated at block 2508, for example, a non-lead party may generate a multiplication key from the multiplication key generated by the lead party (see block 2506). As further indicated at block 2509, a non-lead party may generate a rotation key from a previous rotation key. This may be repeated for all non-lead parties, for example.

In an implementation, multiplication keys (e.g., all multiplication keys) may be summed together, as indicated at block 2510. Also, rotation keys (e.g., all rotation keys) may be summed together, as indicated at block 2511, for example, to generate final rotation keys 2513. In an implementation, individual parties (e.g., all individual parties) may multiply their secrets into the summed multiplication key, as indicated at block 2512, and/or secret-multiplied multiplication keys (e.g., all secret-multiplication keys) may be summed together, as indicated at block 2514, to generate final multiplication keys, as indicated at block 2515.

FIG. 26 provides flow diagrams illustrating an embodiment 2610 of an example ReEncryption operation and an embodiment 2620 of an example ReduceWithInternalMod operation. Embodiments may include all of the operations described, fewer than the operations described, and/or more than the operations described in example processes 2610 and/or 2620. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features.

A key 2627 is provided to aid in understanding the various example operations depicted at blocks 2610-2616 and/or 2620-2626. Of course, subject matter is not limited in scope to the particular operations and/or processes shown at blocks 2610-2611 and/or 2620-2626.

As indicated, example process 2610 (ReEncrypt) may be directed to re-encrypting an already-encrypted A and B vectors, for example, with a new desired key without revealing the key. For example, ReEncrypt( ) (e.g., example process 2610) may homomorphically encrypt already encrypted A and B vectors, for example. In an implementation, ReEncrypt( ) may accept as inputs a ciphertext to be re-encrypted and two two-dimensional vectors that may be referred to as redDataA and redDataB. Also, in an implementation, ReEncrypt( ) may generate an output comprising a two-dimensional array of ciphertexts, for example.

In an implementation, ReEncrypt( ) may include extracting all encrypted information from the ciphertext in the form of two two-dimensional vectors cv0 and cv1, as indicated at block 2611. Further, as indicated at block 2612, ReEncrypt( ) may include creating three two-dimensional vectors called DigitsC2 of the same size as cv1 at least in part by decomposing each elements in cv1 utilizing CRTrns, for example. In an implementation, operation(s) ReduceWithInternalMod(DigitsC2) may be performed, as indicated by block 2613. See example process 2620, discussed more fully below.

As indicated at block 2614, let cv0_Ciphertext=homomorphic sum of its original values plus the homomorphic dot product of digitsC2 and redDataB, for example. Further, as indicated at block 2615, let cv1_Ciphertext=homomorphic sum of its original values plus the homomorphic dot product of digitsC2 (except the first element) and redDataA (except the first element), in an implementation. Additionally, as indicated at block 2616, ReEncrypt( ) may include packing cv0_Ciphertext and cv1_Ciphertext to a two-dimensional array of ciphertexts to generate the specified output (e.g., two-dimensional array of ciphertexts).

As indicated, example process 2620 (ReduceWithInternalMod) may be directed to addressing the problem of most encryption systems not being able to encrypt larger than 32-bit numbers. In an implementation, ReduceWithInternalMod( ) is directed to converting arrays (e.g., of N elements) with each elements of size 60-bits, for example, into three (of N elements) arrays with each elements of size less than 30-bit, for example. In an implementation, example process 2620 (ReduceWithInternalMod) may accept as inputs three two-dimensional arrays of integers called digitsC2 each with N elements. Also, in an implementation, ReduceWithInternalMod( ) may generate an output comprising a two times the number of integers in the input, for example.

As indicated at block 2621, example process 2620 may include implementing nested for-loops to iterate through the inner-most elements of digitsC2 (each inner-most element can be up to 60-bits long), in an implementation. Further, as indicated at block 2622, some number, MOD, which is small enough to guarantee that elements in digitsC2/MOD<32 bits, may be selected. Here, for example, MOD=16384.

In implementations, digitsC2 may be duplicated twice and the duplicates may be labeled digitsC2′ and digitsC2″, for example, as indicated at block 2623. As further indicated at block 2624, quotients of the inner-most values of digitsC2 divided by MOD may be stored in digitsC2′. Block 2625 indicates to store residues of the inner-most values of digitsC2 modulus by MOD in digitsC2″, in an implementation. Additionally, to generate the specified output, example process 2620 may further include packing each element of digitsC2′ and digitsC2″ into a two-dimensional array, as indicated at block 2626.

FIG. 27 shows flow diagrams illustrating an embodiment 2710 of an example Decrypt operation and an embodiment 2720 of an example Decrypt2 operation. Embodiments may include all of the operations described, fewer than the operations described, and/or more than the operations described in example processes 2710 and/or 2720. Likewise, it should be noted that content acquired or produced, such as, for example, input signals, output signals, operations, results, etc. associated with the example provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the description below references particular aspects and/or features illustrated in certain other figures, one or more operations may be performed with other aspects and/or features. Key 2724 is provided to aid in understanding the various example operations depicted at blocks 2710-2711 and/or 2720-2723. It may be noted that subject matter is not limited in scope to the particular operations and/or processes shown at blocks 2710-2711 and/or 2720-2723.

As indicated, example process 2710 (Decrypt) may be directed to addressing the problem of producing partial decryptions of encrypted objects. In general, Decrypt( ) may store partial decrypts for a provided secret key to a global data store. In an implementation, Decrypt( ) may receive as inputs a secret key and a secret key name. For an output, Decrypt( ) may store partially decrypted objects to a data store, for example. Further, as indicated at block 2711, Decrypt( ) (example process 2710) may include decrypting the inner-most elements of an encrypted re-encryption key utilizing the provided secret key (e.g., obtained as an input).

Example process 2720 (Decrypt2) may be directed to decrypting the inner-most elements of a re-encrypted key and combining them with partials from other multiparty keys and then using the results to re-encryp ciphertext to a new key. In an implementation, Decrypt2( ) may receive as inputs a secret key (Input1), a ciphertext (Input2) and encrypted re-encryption key components (Input3). For an output, Decrypt2( ) may generate a ciphertext under a re-encryption key.

In implementations, as indicated at block 2721, Decrypt2( ) (example process 2720) may include decrypting the inner-most components of Input3 (encrypted re-encryption key components). Example process 2720 may also include recombining the decrypted inputs of Input3 into a functioning re-encryption key, as indicated at block 2722, and may further include, optionally, re-encrypting the input with a functioning, newly assembled re-encryption key.

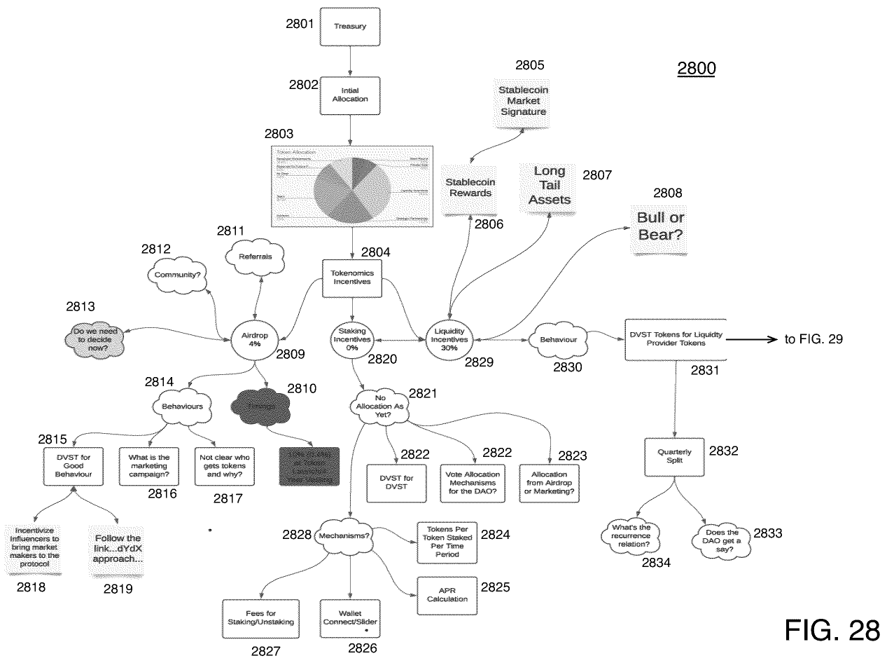

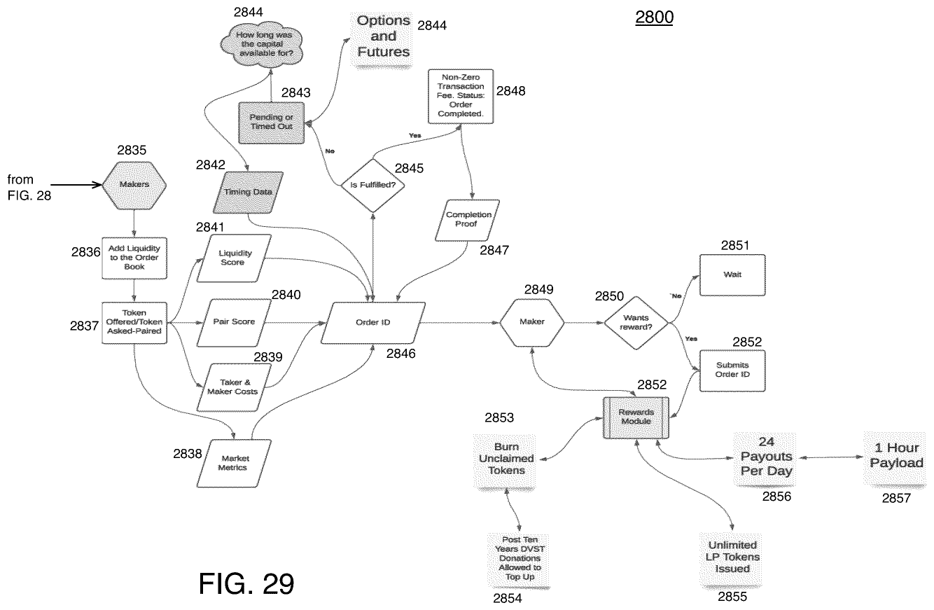

FIGS. 28 and 29 depict an additional example process 2800 comprising an example embodiment of a tokenomics platform and/or one or more practical applications thereof in the context of the present disclosure. In implementations, process 2800 may include a number of example operations depicted at self-explanatory blocks 2801-2857. The example protocols and/or processes described herein are merely examples, and subject matter is not limited in scope in these respects. Embodiments may include all of the operations described, fewer than the operations described, and/or more than the operations described. Likewise, it should be noted that content acquired or produced, such as, for example, input signals, output signals, operations, results, etc. associated with the examples provided may be represented via one or more analog and/or digital signals and/or signal packets. It should also be appreciated that even though one or more operations are illustrated or described concurrently or with respect to a certain sequence, other sequences or concurrent operations may be employed. Further, it should be noted that operations may be implemented, performed, etc. by any combination of hardware, firmware and/or software. In addition, although the descriptions herein references particular aspects and/or features illustrated in certain other figures, one or more operations may be performed with other aspects and/or features. It may be further noted that subject matter is not limited in scope to the particular details of example process 2800.

In the context of the present patent application, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Additionally, in the present patent application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, that the particular situation be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques unless otherwise expressly indicated.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter. Rather, it is asserted, that physical measurements are not mental steps and, likewise, are not abstract ideas.

It is noted, nonetheless, that a typical measurement model employed is that one or more measurements may respectively comprise a sum of at least two components. Thus, for a given measurement, for example, one component may comprise a deterministic component, which in an ideal sense, may comprise a physical value (e.g., sought via one or more measurements), often in the form of one or more signals, signal samples and/or states, and one component may comprise a random component, which may have a variety of sources that may be challenging to quantify. At times, for example, lack of measurement precision may affect a given measurement. Thus, for claimed subject matter, a statistical or stochastic model may be used in addition to a deterministic model as an approach to identification and/or prediction regarding one or more measurement values that may relate to claimed subject matter.

For example, a relatively large number of measurements may be collected to better estimate a deterministic component. Likewise, if measurements vary, which may typically occur, it may be that some portion of a variance may be explained as a deterministic component, while some portion of a variance may be explained as a random component. Typically, it is desirable to have stochastic variance associated with measurements be relatively small, if feasible. That is, typically, it may be preferable to be able to account for a reasonable portion of measurement variation in a deterministic manner, rather than a stochastic matter as an aid to identification and/or predictability.

Along these lines, a variety of techniques have come into use so that one or more measurements may be processed to better estimate an underlying deterministic component, as well as to estimate potentially random components. These techniques, of course, may vary with details surrounding a given situation. Typically, however, more complex problems may involve use of more complex techniques. In this regard, as alluded to above, one or more measurements of physical manifestations may be modeled deterministically and/or stochastically. Employing a model permits collected measurements to potentially be identified and/or processed, and/or potentially permits estimation and/or prediction of an underlying deterministic component, for example, with respect to later measurements to be taken. A given estimate may not be a perfect estimate; however, in general, it is expected that on average one or more estimates may better reflect an underlying deterministic component, for example, if random components that may be included in one or more obtained measurements, are considered. Practically speaking, of course, it is desirable to be able to generate, such as through estimation approaches, a physically meaningful model of processes affecting measurements to be taken.

In some situations, however, as indicated, potential influences may be complex. Therefore, seeking to understand appropriate factors to consider may be particularly challenging. In such situations, it is, therefore, not unusual to employ heuristics with respect to generating one or more estimates. Heuristics refers to use of experience related approaches that may reflect realized processes and/or realized results, such as with respect to use of historical measurements, for example. Heuristics, for example, may be employed in situations where more analytical approaches may be overly complex and/or nearly intractable. Thus, regarding claimed subject matter, an innovative feature may include, in an example embodiment, heuristics that may be employed, for example, to estimate and/or predict one or more measurements.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present patent application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present patent application, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present patent application, use of the term “Hadoop” is intended to include versions, presently known and/or to be later developed.

In the context of the present patent application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present patent application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present patent application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present patent application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present patent application, may comprise a service that organizes stored digital content, such as, for example, text, images, video, etc., through the use of hypermedia, for example. It is noted that a network, such as the Internet and/or Web, may be employed to store electronic files and/or electronic documents.

The term electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present patent application, the term “Web site” and/or similar terms refer to Web pages that are associated electronically to form a particular collection thereof. Also, in the context of the present patent application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present patent application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, 4G, or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

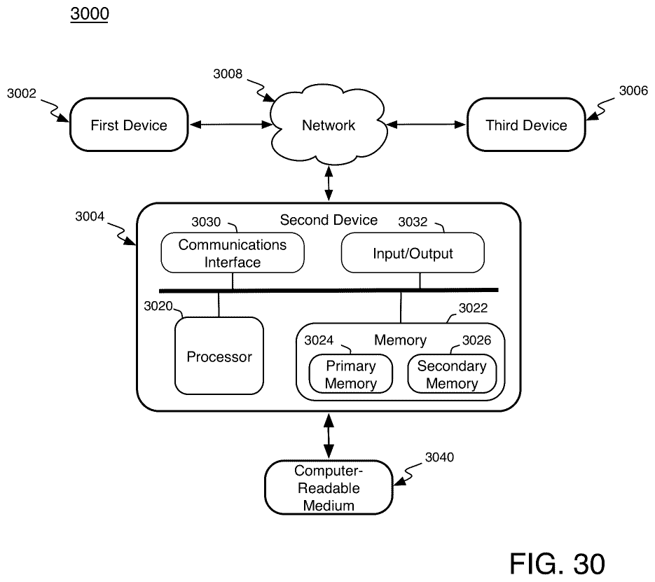

In one example embodiment, as shown in FIG. 30, a system embodiment may comprise a local network (e.g., device 3004 and medium 3040) and/or another type of network, such as a computing and/or communications network. For purposes of illustration, therefore, FIG. 30 shows an embodiment 3000 of a system that may be employed to implement either type or both types of networks. Network 3008 may comprise one or more network connections, links, processes, services, applications, and/or resources to facilitate and/or support communications, such as an exchange of communication signals, for example, between a computing device, such as 3002, and another computing device, such as 3006, which may, for example, comprise one or more client computing devices and/or one or more server computing device. By way of example, but not limitation, network 3008 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 30 may comprise features, for example, of a client computing device and/or a server computing device, in an embodiment. It is further noted that the term computing device, in general, whether employed as a client and/or as a server, or otherwise, refers at least to a processor and a memory connected by a communication bus. Likewise, in the context of the present patent application at least, this is understood to refer to sufficient structure within the meaning of 35 USC § 112 (f) so that it is specifically intended that 35 USC § 112 (f) not be implicated by use of the term “computing device” and/or similar terms, however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 1-17b and in the text associated at least with the foregoing figure(s) of the present patent application.

Referring now to FIG. 30, in an embodiment, first and third devices 3002 and 3006 may be capable of rendering a graphical user interface (GUI) for a network device and/or a computing device, for example, so that a user-operator may engage in system use. Device 3004 may potentially serve a similar function in this illustration. Likewise, in FIG. 30, computing device 3002 (‘first device’ in figure) may interface with computing device 3004 (‘second device’ in figure), which may, for example, also comprise features of a client computing device and/or a server computing device, in an embodiment. Processor (e.g., processing device) 3020 and memory 3022, which may comprise primary memory 3024 and secondary memory 3026, may communicate by way of a communication bus 3015, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, sensor content, etc. in the form of signals and/or states. Thus, a computing device, in the context of the present patent application, may comprise hardware, software, firmware, or any combination thereof (other than software per se). Computing device 3004, as depicted in FIG. 30, is merely one example, and claimed subject matter is not limited in scope to this particular example.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, endpoint and/or sensor nodes, gateway devices, streaming devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

As suggested previously, communications between a computing device and/or a network device and a wireless network may be in accordance with known and/or to be developed network protocols including, for example, global system for mobile communications (GSM), enhanced data rate for GSM evolution (EDGE), 802.11b/g/n/h, etc., and/or worldwide interoperability for microwave access (WiMAX). A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that is may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computing device operating systems, such as Windows, macOS, iOS, Linux, and/or the like, and/or mobile device operating systems, such as iOS, Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, sensor content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

In FIG. 30, computing device 3002 may provide one or more sources of executable computer instructions in the form physical states and/or signals (e.g., stored in memory states), for example. Computing device 3002 may communicate with computing device 3004 by way of a network connection, such as via network 3008, for example. As previously mentioned, a connection, while physical, may not necessarily be tangible. Although computing device 3004 of FIG. 30 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 3022 may comprise any non-transitory storage mechanism. Memory 3022 may comprise, for example, primary memory 3024 and secondary memory 3026, additional memory circuits, mechanisms, or combinations thereof may be used. Memory 3022 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 3022 may be utilized to store a program of executable computer instructions. For example, processor 3020 may fetch executable instructions from memory and proceed to execute the fetched instructions. Memory 3022 may also comprise a memory controller for accessing device readable-medium 3040 that may carry and/or make accessible digital content, which may include code, and/or instructions, for example, executable by processor 3020 and/or some other device, such as a controller, as one example, capable of executing computer instructions, for example. Under direction of processor 3020, a non-transitory memory, such as memory cells storing physical states (e.g., memory states), comprising, for example, a program of executable computer instructions, may be executed by processor 3020 and able to generate signals to be communicated via a network, for example, as previously described. Generated signals may also be stored in memory, also previously suggested.

Memory 3022 may store electronic files and/or electronic documents, such as relating to one or more users, and may also comprise a computer-readable medium that may carry and/or make accessible content, including code and/or instructions, for example, executable by processor 3020 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 30, processor 3020 may comprise one or more circuits, such as digital circuits, to perform at least a portion of a computing procedure and/or process. By way of example, but not limitation, processor 3020 may comprise one or more processors, such as controllers, microprocessors, microcontrollers, application specific integrated circuits, digital signal processors, programmable logic devices, field programmable gate arrays, the like, or any combination thereof. In various implementations and/or embodiments, processor 3020 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 30 also illustrates device 3004 as including a component 3032 operable with input/output devices, for example, so that signals and/or states may be appropriately communicated between devices, such as device 3004 and an input device and/or device 3004 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method, comprising:
electronically generating one or more computationally verifiable smart contract templates substantially in accordance with at least layer 0 and/or layer 1 of one or more distributed network technologies.

2. The method of claim 1, wherein the one or more distributed network technologies comprise one or more blockchain-type technologies.

3. The method of claim 1, wherein the one or more computationally verifiable smart contract templates comprise one or more maker and/or taker templates, wherein the maker and/or taker templates comprise self-validating characteristics.

4. The method of claim 3, further comprising:
obtaining an input from a maker, wherein the input obtained from the maker indicates initiation of a first claim via an exchange contract to offer to obtain a particular amount of a first cryptographic asset in exchange for a particular amount of a second cryptographic asset.

5. The method of claim 4, wherein the exchange contract comprises a cryptographic protocol to manage an exchange of cryptographic assets between at least the maker and a taker.

6. The method of claim 5, further comprising:
obtaining an input from the taker, wherein the input obtained from the taker indicates an intent to perform a swap of the particular amount of the first cryptographic asset for the particular amount of the second cryptographic asset.

7. The method of claim 6, further comprising the taker appending a second claim to the first claim via the exchange contract to indicate an intent of the taker to perform the swap of cryptographic assets.

8. The method of claim 7, further comprising the exchange contract recruiting a validator and the exchange contract communicating with a calculation contract to determine compensation for the maker to receive as a rebate.

9. The method of claim 8, further comprising the exchange contract instructing a treasury contract to prepare to pay the rebate to the maker following the exchange of cryptographic assets.

10. The method of claim 9, further comprising the exchange contract instructing the maker, taker and validator to register threshold keys and to trade IDs.

11. An apparatus comprising:
one or more processors coupled to a memory to:
electronically generate one or more computationally verifiable smart contract templates substantially in accordance with at least layer 0 and/or layer 1 of one or more distributed network technologies.

12. The apparatus of claim 11, wherein the one or more distributed network technologies comprise one or more blockchain-type technologies and wherein the one or more computationally verifiable smart contract templates comprise one or more maker and/or taker templates, wherein the maker and/or taker templates comprise self-validating characteristics.

13. The apparatus of claim 12, wherein the one or more processors further to:
obtain an input from a maker, wherein the input obtained from the maker to indicate initiation of a first claim via an exchange contract to offer to obtain a particular amount of a first cryptographic asset in exchange for a particular amount of a second cryptographic asset, wherein the exchange contract to comprise a cryptographic protocol to manage an exchange of cryptographic assets between at least the maker and a taker.

14. The apparatus of claim 13, wherein the one or more processors further to:
obtain an input from the taker, wherein the input obtained from the taker to indicate an intent to perform a swap of the particular amount of the first cryptographic asset for the particular amount of the second cryptographic asset, wherein the taker to append a second claim to the first claim via the exchange contract to indicate an intent of the taker to perform the swap of cryptographic assets.

15. The apparatus of claim 14, wherein the one or more processors further to, via the exchange contract, recruit a validator, communicate with a calculation contract to determine compensation for the maker to receive as a rebate, instruct a treasury contract to prepare to pay the rebate to the maker following the exchange of cryptographic assets, and instructing the maker, taker and validator to register threshold keys and to trade IDs.

16. An article comprising:
a non-transitory storage medium having instructions stored thereon executable by a special purpose computing platform to:
electronically generate one or more computationally verifiable smart contract templates substantially in accordance with at least layer 0 and/or layer 1 of one or more distributed network technologies, wherein the one or more distributed network technologies comprise one or more blockchain-type technologies.

17. The article of claim 16, wherein the one or more computationally verifiable smart contract templates comprise one or more maker and/or taker templates, and wherein the maker and/or taker templates comprise self-validating characteristics.

18. The article of claim 17, wherein the instructions are further executable by the special purpose computing platform to:
obtain an input from a maker, wherein the input obtained from the maker to indicate initiation of a first claim via an exchange contract to offer to obtain a particular amount of a first cryptographic asset in exchange for a particular amount of a second cryptographic asset, wherein the exchange contract to comprise a cryptographic protocol to manage an exchange of cryptographic assets between at least the maker and a taker.

19. The article of claim 18, wherein the instructions are further executable by the special purpose computing platform to:
obtain an input from the taker, wherein the input obtained from the taker to indicate an intent to perform a swap of the particular amount of the first cryptographic asset for the particular amount of the second cryptographic asset, wherein the taker to append a second claim to the first claim via the exchange contract to indicate an intent of the taker to perform the swap of cryptographic assets.

20. The article of claim 19, wherein the instructions are further executable by the special purpose computing platform to, via the exchange contract:
recruit a validator;
communicate with a calculation contract to determine compensation for the maker to receive as a rebate;
instruct a treasury contract to prepare to pay the rebate to the maker following the exchange of cryptographic assets; and
instructing the maker, taker and validator to register threshold keys and to trade IDs.
